(19) United States
(12) Patent Application Publication
(10) Pub. No.: US 2025/0238670 A1
(43) Pub. Date: Jul. 24, 2025

(54) THERMODYNAMIC COMPUTING SYSTEM CONFIGURED TO USE NATURAL GRADIENT DESCENT TECHNIQUES TO DETERMINE UPDATED WEIGHTS AND BIASES

(71) Applicant: Extropic Corp., Austin, TX (US)

(72) Inventors: Christopher Chamberland, Austin, TX (US); Guillaume Verdon-Akzam, Montreal (CA)

(73) Assignee: Extropic Corp., Austin, TX (US)

(21) Appl. No.: 18/418,934

(22) Filed: Jan. 22, 2024

(51) Int. Cl. G06N 3/08; G06N 3/063

(52) U.S. Cl. CPC G06N 3/08; G06N 3/063

(57) ABSTRACT

A neuro-thermodynamic computer includes a thermodynamic chip that includes oscillators that are mapped to neurons and additional oscillators that are mapped to synapses, wherein the synapses correspond to weights and bias values used to describe relationships between the neurons in an energy-based model. Learning algorithms are described for computing gradients for a positive phase term and a negative phase term, as well as elements of an information matrix based on measurements taken of the synapse oscillators, without a need to fully compute updated weights and biases on classical hardware. However, classical hardware may be used to perform basic operations to convert the measured values into calculated updated weights and biases. The updated weights and bias values are used to train the energy-based model, which once trained, can be used to generate inferences for various types of machine learning or AI-type problems.

### BACKGROUND

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 is high-level diagram illustrating a process of determining weights and biases to be used in a Bayesian algorithm, wherein the weights and biases are determined using measurement values for synapse oscillators of a thermodynamic chip, and wherein visible neuron oscillators of the thermodynamic chip are used to implement, at least in part, the Bayesian algorithm, according to some embodiments.

FIG. 2 is a high-level diagram illustrating synapse oscillator measurements being taken for evolutions of the thermodynamic chip, wherein the visible neuron oscillators of the thermodynamic chip are clamped to mini-batches of input training data during evolutions for which a first set of measurements are taken, and wherein the visible neuron oscillators are left un-clamped during an additional one or more evolutions for which a second set of measurements are taken, according to some embodiments.

FIG. 3 is a high-level diagram illustrating synapse oscillator measurements being taken for evolutions of the thermodynamic chip, wherein a plurality of the measurements are taken at a faster time scale than a time scale required for the synapse oscillators to reach a thermal equilibrium, and wherein the faster measurements of the synapse oscillators are taken during evolutions of both a clamped and an un-clamped configuration of thermodynamic chip, according to some embodiments.

FIG. 4 illustrates an example information matrix that is used in determining updated weight and biases values using a natural gradient descent technique, wherein the components of the information matrix are determined using synapse oscillator measurement results and simple integration, multiplication, and subtraction operations performed by a classical computing device, according to some embodiments.

FIG. 5A is an illustrative diagram showing relative masses and motions of the synapse oscillators and neuron oscillators of a thermodynamic chip at a time T₁ corresponding to an initial portion of an evolution of the thermodynamic chip, according to some embodiments.

FIG. 5B is an illustrative diagram showing the relative masses and motions of the synapse oscillators and the neuron oscillators of the thermodynamic chip at a time T₂ corresponding to a point in time in the evolution wherein the neuron oscillators have reached a thermal equilibrium, but the synapse oscillators have not yet reached thermal equilibrium and continue to evolve, according to some embodiments.

FIG. 5C is an illustrative diagram showing the relative masses and motions of the synapse oscillators and the neuron oscillators of the thermodynamic chip at a time T₃ corresponding to a point in time in the evolution wherein the neuron oscillators and the synapse oscillators have reached thermal equilibrium, according to some embodiments.

FIG. 6 illustrates an example of position measurements being taken of the synapse oscillators between time T₂ and time T₃, wherein a set of position measurements of the synapse oscillators are taken sequentially close in time to one another shortly after the neuron oscillators have reached thermal equilibrium and another set of position measurements of the synapse oscillators are taken sequentially close in time to one another sometime later, which may be shortly before the synapse oscillators reach thermal equilibrium, according to some embodiments.

FIG. 7 illustrates an example of position measurements being taken of the synapse oscillators between time T₂ and time T₃, wherein multiple sets of position measurements of the synapse oscillators are taken sequentially close in time to one another between time T₂ (when the neuron oscillators reach thermal equilibrium) and time T₃ (when the synapse oscillators reach thermal equilibrium), according to some embodiments. Also, in some embodiments, T₃ may occur well before an amount of time required for the synapse oscillators to reach thermal equilibrium.

FIG. 8 illustrates an example of momentum measurements being taken of the synapse oscillators between time T₂ and time T₃, wherein momentum measurements of the synapse oscillators are taken shortly after the neuron oscillators have reached thermal equilibrium and momentum measurements of the synapse oscillators are taken some time later, which may occur shortly before the synapse oscillators reach thermal equilibrium or before, according to some embodiments.

FIG. 9 illustrates an example of momentum measurements being taken of the synapse oscillators between time T₂ (when the neuron oscillators reach thermal equilibrium) and time T₃, according to some embodiments.

FIG. 10 illustrates an example of force measurements being taken of the synapse oscillators between time T₂ and time T₃, wherein force measurements of the synapse oscillators are taken shortly after the neuron oscillators have reached thermal equilibrium and force measurements of the synapse oscillators are taken some time later, which may occur shortly before the synapse oscillators reach thermal equilibrium or before, according to some embodiments.

FIG. 11 illustrates an example of force measurements being taken of the synapse oscillators between time T₂ (when the neuron oscillators reach thermal equilibrium) and time T₃, according to some embodiments.

FIG. 12 is high-level diagram illustrating an example neuro-thermodynamic computer comprising a thermodynamic chip included in a dilution refrigerator and coupled to a classical computing device in an environment external to the dilution refrigerator, according to some embodiments.

FIG. 13 is high-level diagram illustrating an example neuro-thermodynamic computer comprising a thermodynamic chip included in a dilution refrigerator and coupled to a classical computing device that is also included in the dilution refrigerator, according to some embodiments.

FIG. 14 is high-level diagram illustrating an example neuro-thermodynamic computer comprising a thermodynamic chip coupled to a classical computing device in an environment other than a dilution refrigerator, according to some embodiments.

FIG. 15 is a high-level diagram illustrating oscillators included in a substrate of a thermodynamic chip and a mapping of the oscillators to logical neurons or synapses of the thermodynamic chip, according to some embodiments.

FIG. 16 is an additional high-level diagram illustrating oscillators included in a substrate of the thermodynamic chip mapped to logical neurons, weights, and biases (e.g., synapses) of a neuro-thermodynamic computing system, according to some embodiments.

FIG. 17 illustrates example couplings between visible neurons, weights, and biases (e.g., synapses) of a thermodynamic chip, according to some embodiments.

FIG. 18A illustrates example couplings between visible neurons of a thermodynamic chip, according to some embodiments.

FIG. 18B illustrates example couplings between visible neurons and non-visible neurons (e.g., hidden neurons) of a thermodynamic chip, according to some embodiments.

FIGS. 19A-19B illustrate an example algorithm for learning weights and bias values to be used in a Bayesian algorithm, based on position measurements taken of synapse oscillators of a thermodynamic chip, according to some embodiments.

FIGS. 20A-20B illustrate an example algorithm for learning weights and bias values to be used in a Bayesian algorithm, based on momentum and/or force measurements taken of synapse oscillators of a thermodynamic chip, according to some embodiments.

FIG. 21 illustrates an example apparatus for measuring positions of oscillators of a thermodynamic chip using a flux read-out device, according to some embodiments.

FIG. 22 illustrates an example apparatus for measuring momentums of oscillators of a thermodynamic chip using a charge read-out device, according to some embodiments.

FIG. 23 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems, and an apparatus for performing computer operations using a thermodynamic chip. In some embodiments, a neuro-thermodynamic processor may be configured such that learning algorithms for learning parameters of an energy-based model may be applied using Langevin dynamics. For example, as described herein, a thermodynamic chip of a neuro-thermodynamic processor may be configured such that, given a Hamiltonian that describes the energy-based model, weights and biases (e.g., synapses) may be calculated based on measurements taken from the thermodynamic chip as it naturally evolves according to Langevin dynamics. For example, a positive phase term, a negative phase term, associated gradients, and elements of an information matrix needed to determine updated weights and biases for the energy-based model may be simply computed on an accompanying classical computing device, such as a field programmable gate array (FPGA) or application specific integrated circuit (ASIC), based on measurements taken from the oscillators of the thermodynamic chip. Such calculations performed on the accompanying classical computing device may be simple and non-complex as compared to other approaches that use the classical computing device to determine statistical probabilities (e.g., without using a thermodynamic chip). For example, a natural gradient descent technique for learning parameters of a machine model, implemented using a thermodynamic processor, may be learned using oscillator measurements and non-complex calculations performed on a classical computing device. As described herein, non-complex calculations may include multiplication, subtraction, integration over time (e.g. of measured values), etc. and may avoid more complex calculations, such as statistical probability calculations, typically used in other approaches for using natural gradient descent techniques.

More particularly, physical elements of a thermodynamic chip may be used to physically model evolution according to Langevin dynamics. For example, in some embodiments, a thermodynamic chip includes a substrate comprising oscillators implemented using superconducting flux elements. The oscillators may be mapped to neurons (visible or hidden) that “evolve” according to Langevin dynamics. For example, the oscillators of the thermodynamic chip may be initialized in a particular configuration and allowed to thermodynamically evolve. As the oscillators “evolve” degrees of freedom of the oscillators may be sampled. Values of these sampled degrees of freedom may represent, for example, vector values for neurons or synapses that evolve according to Langevin dynamics. For example, algorithms that use stochastic gradient optimization and require sampling during training, such as those proposed by Welling and Teh, and/or other algorithms, such as natural gradient descent, mirror descent, etc. may be implemented using a thermodynamic chip. In some embodiments, a thermodynamic chip may enable such algorithms to be implemented directly by sampling the neurons and/or synapses (e.g., degrees of freedom of the oscillators of the substrate of the thermodynamic chip) without having to calculate statistics to determine probabilities. As another example, thermodynamic chips may be used to perform autocomplete tasks, such as those that use Hopfield networks, which may be implemented using natural gradient descent. For example, visible neurons may be arranged in a fully connected graph (such as a Hopfield network, etc.), and the values of the auto complete task may be learned using a natural gradient descent algorithm.

In some embodiments, a thermodynamic chip includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that have dual-well potentials. These dual-well oscillators may be mapped to neurons of a given energy-based model that the thermodynamic chip is being used to implement. Also, in some embodiments, at least some of the oscillators may be harmonic oscillators with single-well potentials. In some embodiments, oscillators may be implemented using superconducting flux elements with varying amounts of non-linearity. In some embodiments, an oscillator may have a single well potential, a dual-well potential, or a potential somewhere in a range between a single-well potential and a dual-well potential. In some embodiments, visible neurons may be mapped to oscillators having a single well potential, a dual-well potential, or a potential somewhere in a range between a single-well potential and a dual-well potential.

In some embodiments, oscillators of the thermodynamic chip may also be used to represent values of weights and biases of the energy-based model. Thus, weights and biases that describe relationships between neurons may also be represented as dynamical degrees of freedom, e.g., using oscillators of the thermodynamic chip (e.g., synapse oscillators).

In some embodiments, parameters of an energy-based model or other learning algorithm may be learned through evolution of the oscillators of a thermodynamic chip.

As mentioned above, in some embodiments, the weights and biases of an energy-based model are dynamical degrees of freedom (e.g., oscillators of a thermodynamic chip), in addition to neurons (hidden or visible) being dynamic degrees of freedom (e.g., represented by other oscillators of the thermodynamic chip). In such configurations, gradients needed for learning algorithms can be obtained by performing measurements of the synapse oscillators, such as position measurements or momentum measurements. For example, measurements of the synapse oscillators (position or momentum) performed on a time scale proportional to a thermalization time of the synapse oscillators, or on shorter time scales than the thermalization times of the synapse oscillators, can be used to compute time-averaged gradients. In some embodiments, the variance of the time average gradient (determined using synapse oscillator measurements) scales as 1/t where t is the total measurement time. Also, expectation values for an information matrix may be calculated based on the measurements of the synapse oscillators. For example, the information matrix may be used in natural gradient descent to guide the search for updated weight and bias values. In some embodiments, the expectation values of the information matrix may provide respective measures of how much information a parameter used to determine the weights and biases carries with regard to a distribution that models at least a portion of the energy-based model. These gradients, along with the determined information matrix, can be used to calculate new weights and bias values that may be used as synapse values in an updated version of the energy-based model. The process of making measurements and determining updated weights and biases may be repeated multiple times until a learning threshold for the energy-based model has been reached.

For example, there are various learning algorithms where one must use both positive and negative phase terms to perform parameter updates. For instance, in the implementation by Welling and Teh the parameters are updated as follows:

$${θ}_{t + 1} = {θ}_{t} + \frac{{ϵ}_{t}}{2} ( - {∇}_{{θ}_{t}} {ε}_{p} ( {θ}_{t} ) ) - N ( \frac{1}{n} {\sum }_{i = 1}^{n} {∇}_{{θ}_{t}} ε ( {θ}_{t} , {x}_{{t}_{i}} ) - {𝔼}_{x \sim {p}_{{θ}_{t}} ( x )} [ {∇}_{{θ}_{t}} ε ( {θ}_{t} , x ) ] ) + {η}_{t}$$

where εₚ(θₜ) is some prior potential and the probability distribution for an energy-based model (EBM) with parameters θₜ given by pθₜ(x)=e^{-ε(θ}^{ₜ}^{,x)}/Z, where Z is a partition function. In the above equation, the first gradient term, where the visible nodes are clamped to the data will be referred to as the positive phase term. The second gradient term, where the visible nodes are sampled from x˜pθₜ(x) will be referred to as the negative phase term (e.g., where the visible nodes are unclamped). When hidden neurons are present, the parameter update rule is given by:

$${θ}_{t + 1} = {θ}_{t} + \frac{{ϵ}_{t}}{2} ( - {∇}_{{θ}_{t}} {ε}_{p} ( {θ}_{t} ) ) - N ( \frac{1}{n} {\sum }_{i = 1}^{n} {𝔼}_{z \sim {p}_{{θ}_{t}} ( z \vert {x}_{{t}_{i}} )} [ {∇}_{{θ}_{t}} ε ( {θ}_{t} , {x}_{{t}_{i}} , z ) ] - {𝔼}_{( x , z ) \sim {p}_{{θ}_{t}} ( x , z )} [ {∇}_{{θ}_{t}} ε ( {θ}_{t} , x , z ) ] ) + {η}_{t}$$

Similar update rules are also found in natural gradient descent, wherein an information matrix is used in addition to the gradient terms. For example, in natural gradient descent, parameters may be updated using the following equation:

$${θ}_{t + 1} = {θ}_{t} + \frac{1}{{λ}_{t}} {I}^{+} ( {θ}_{t} ) ( - {∇}_{θ} {ε}_{p} ( {θ}_{t} ) - N ( \frac{1}{n} {\sum }_{i = 1}^{n} {∇}_{{θ}_{t}} ε ( {θ}_{t} , {x}_{{t}_{i}} ) - {𝔼}_{( x ) \sim {p}_{{θ}_{t}} ( x )} [ {∇}_{{θ}_{t}} ε ( {θ}_{t} , x ) ] ) )$$

where λₜ is a learning rate and I⁺(θ) is the Moore-Penrose pseudo inverse of the information matrix I(θ). In some embodiments, expectation values included in the information matrix can be calculated using the Bogoliubov-Kubo-Mori (BKM) metric (denoted I_{BKM}(θ)), which is a special choice of the metric I(θ). For example, the BKM metric for energy-based models (such as those implemented using one or more thermodynamic chips, as described herein) is defined as:

$${{I}^{BKM} ( θ )}_{j , k} = \int ( {\partial }_{{θ}_{j}} , {p}_{θ} ( x ) ) ( {\partial }_{{θ}_{k}} log {p}_{θ} ( x ) )$$

where p_{θ}(x)=exp(−ε_{θ}(x)/Z(θ). Also, using the definition (just given) for p_{θ}(x), the terms in the BKM metric equation can be calculated where the first term is given by:

$${\partial }_{{θ}_{j}} , {p}_{θ} ( x ) = ( {𝔼}_{( z ) ∼ {p}_{θ} ( z )} [ {\partial }_{{θ}_{j}} {ℰ}_{θ} ( z ) ] - {\partial }_{{θ}_{j}} , {ℰ}_{θ} ( x ) ) {p}_{θ} ( x )$$

and the second term is given by:

$${\partial }_{{θ}_{k}} log {p}_{θ} ( x ) = ( - {\partial }_{{θ}_{k}} , {ℰ}_{θ} ( x ) + {𝔼}_{( y ) ∼ {p}_{θ} ( y )} [ {\partial }_{{θ}_{k}} {ℰ}_{θ} ( y ) ] ) .$$

With the first and second terms of the BKM metric equation calculated as described above, the BKM metric can be rewritten as:

$${{I}^{B K M} ( θ )}_{j , k} = {𝔼}_{( x ) ∼ {p}_{θ} ( x )} [ {\partial }_{{θ}_{j}} {ℰ}_{θ} ( x ) {\partial }_{{θ}_{k}} {ℰ}_{θ} ( x ) ] - {𝔼}_{( x ) ∼ {p}_{θ} ( x )} [ {\partial }_{{θ}_{j}} {ℰ}_{θ} ( x ) ] {𝔼}_{( y ) ∼ {p}_{θ} ( y )} [ {\partial }_{{θ}_{k}} {ℰ}_{θ} ( y ) ] .$$

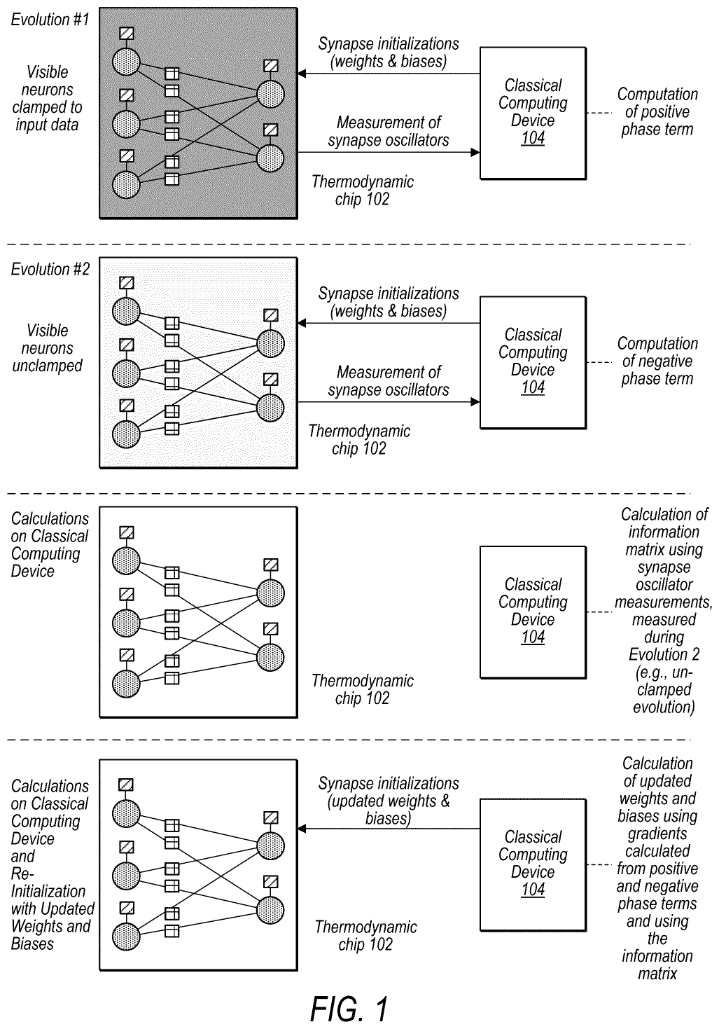

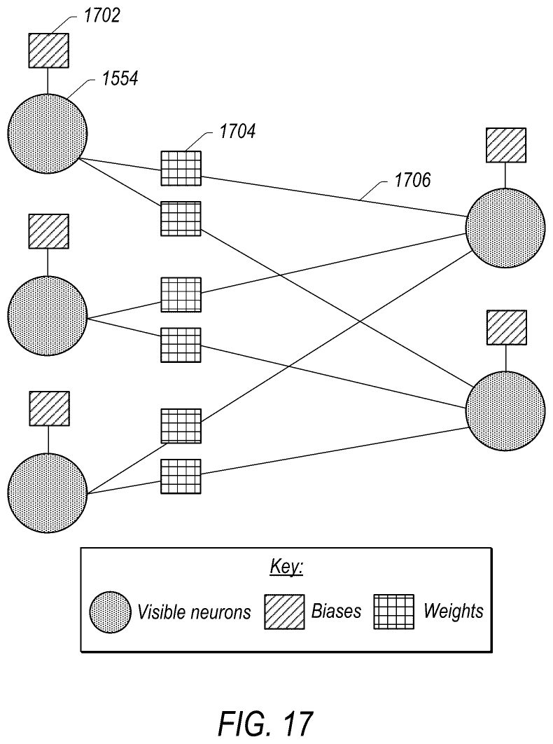

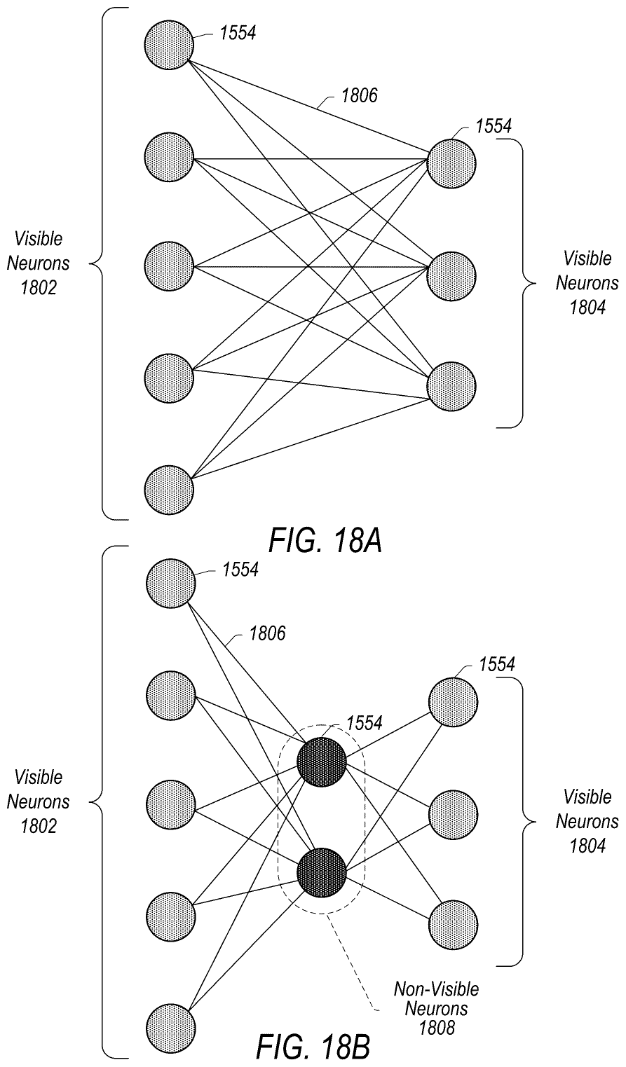

For a neuro-thermodynamic processor, such as shown in FIG. 1 and also shown in more detail in FIGS. 16-17, which includes visible neurons coupled via weights and biases that are also represented by degrees of freedom (e.g., synapse oscillators), the dynamics of the system for a three-body coupling between the synapse oscillators and the neuron oscillators (visible or hidden) are described by the following Hamiltonian:

$${H}_{total} = {\sum }_{j ∈ {V}_{v i s}} ( \frac{{p}_{{n}_{j}}^{2}}{2 {m}_{{n}_{j}}^{( v )}} + {{E}_{L}^{( v )} ( {φ}_{{n}_{j}} - {\tilde{φ}}_{L}^{( v )} )}^{2} + {E}_{J 0}^{( v )} cos ( {\tilde{φ}}_{D C}^{( v )} / 2 ) ( 1 - cos ( {φ}_{{n}_{j}} ) ) ) + {\sum }_{k , l ∈ ℰ} ( \frac{{p}_{{s}_{j}}^{2}}{2 {m}_{{s}_{k , l}}^{( w )}} + {{E}_{L}^{( w )} ( {φ}_{{s}_{k , l}} - {\tilde{φ}}_{L}^{( w )} )}^{2} + {E}_{J 0}^{( w )} cos ( {\tilde{φ}}_{D C}^{( w )} / 2 ) ( 1 - cos ( {φ}_{{s}_{k , l}} ) ) ) + {\sum }_{j ∈ {V}_{v i s}} ( \frac{{p}_{{b}_{j}}^{2}}{2 {m}_{{b}_{j}}^{( b )}} + {{E}_{L}^{( b )} ( {φ}_{{b}_{j}} - {\tilde{φ}}_{L}^{( b )} )}^{2} + {E}_{J 0}^{( b )} cos ( {\tilde{φ}}_{D C}^{( b )} / 2 ) ( 1 - cos ( {φ}_{{b}_{j}} ) ) ) + ( α {\sum }_{\{ k , l \} ∈ ℰ} {φ}_{{s}_{k l}} {φ}_{{n}_{k}} {φ}_{{n}_{l}} + β {\sum }_{j ∈ V} {φ}_{{n}_{j}} {φ}_{{b}_{j}} ) .$$

Note that the above Hamiltonian uses a representation of couplings between neuron oscillators and synapse oscillators given by the terms proportional to alpha and beta. However, in some embodiments, a Hamiltonian with more general terms may be used. The above Hamiltonian is given as an example of an energy-based model, but others may be used within the scope of the present disclosure.

In some embodiments, the neurons used to encode the input data are based on a flux qubit design, wherein neurons are described by a phase/flux degree of freedom and the design is based on the DC SQUID which contains two junctions. In the above Hamiltonian, Eⱼ denotes the Josephson energy, L corresponds to the inductance of the main loop, and results in the inductive energy E_{L}. Also, \tilde{φ}_{L} represents the external flux coupled to the main loop and \tilde{φ}_{DC} is the external flux coupled into the DC SQUID loop. Since the visible neurons, as well as the weights/biases, all evolve according to Langevin dynamics, their equations of motion can be written as:

$$\frac{d {q}_{k} ( t )}{d t} = \frac{\partial {H}_{t o t a l}}{\partial {p}_{k}}$$

$${\frac{d {p}_{k} ( t )}{dt} = - γ {p}_{k} ( t ) - \frac{\partial {H}_{t o t a l}}{\partial {q}_{k}} \vert}_{t} + \sqrt{2 {m}_{k} γ {k}_{B} T} \frac{d {W}_{t}}{dt} .$$

where qₖ is used to label the k'th element of the position vector, and pₖ is used to label the k'th element of the momentum vector. Also, as used herein superscripts may be used to distinguish positions (or momentums or forces) of neurons, weights and biases. For (w) example, as qₓ⁽ⁿ⁾ (neurons), qₖ^{(w)} (weights), and qₖ^{(b)} biases). Also, as used below γ is used to label friction, mₖ denotes the mass of a given neuron degree of freedom, such as a mass of a weight degree of freedom, or mass of a bias degree of freedom, and k_{B}T corresponds to the Boltzmann's constant times the temperature of the thermodynamic chip (system). Also, Wₜ represents a Wienner process.

In some embodiments, momentum measurements of the synapse oscillators may be used to obtain time averaged gradients, such as for the un-clamped phase, wherein the visible neuron oscillators are not clamped to input data. The protocols described herein can also be used in configurations that include hidden neurons. In systems wherein the visible (or hidden) neuron oscillators have smaller masses than the synapse oscillators and therefore reach thermal equilibrium at a faster time scale than is required for the synapse oscillators to reach thermal equilibrium, the Langevin equations for the synapses can be as follows:

$$\frac{\partial {q}_{k} ( t )}{d t} = \frac{\partial {H}_{total}}{\partial {p}_{k}}$$

$${\frac{\partial {p}_{k} ( t )}{d t} = - γ {p}_{k} ( t ) - \frac{\partial {U}_{e f f}}{\partial {q}_{k}} \vert}_{t} + \sqrt{2 {m}_{k} γ {k}_{B} T} \frac{d {W}_{t}}{d t}$$

$$with$$

$${U}_{e f f} ( q , x , z ) = {U}_{s} ( q ) + {𝔼}_{( x , z ) ∼ {P}_{2}} [ {U}_{c} ( q , x , z ) ]$$

where qₖ denotes the k'th synapse and x and z denote the visible and hidden neurons. Also, P₂ denotes the probability distribution for the neurons in thermal equilibrium. Using the overall system Hamiltonian given previously above, Uₛ(q)=ΣₖE_{L}(qₖ−c)² (assuming a single well potential type oscillator is used). Also, U_{c}((q,x,z)=αΣ_{(k,i,j)∈ε}qₖ\tilde{x}ᵢ\tilde{x}ⱼ+βΣ_{k∈Y}qₖ\tilde{x}ₖ where \tilde{x} denotes a visible or hidden neuron, and ε and γ denote the set of weights and biases used for the synapses. Integrating yields:

$${{p}_{k} ( t ) - {p}_{k} ( 0 ) + γ {\int }_{0}^{t} {p}_{k} ( τ ) d τ = - {\int }_{0}^{t} \frac{\partial {U}_{e f f} ( q , x , z )}{\partial {q}_{k}} \vert}_{τ} d τ + \sqrt{2 {m}_{k} γ {k}_{B} T} {\int }_{0}^{T} d {W}_{τ}$$

where q, x and z correspond to the positions of the synapses, visible and hidden neurons, respectively. In what follows, it can be assumed that the masses of the synapses are large enough such that in the time interval from 0 to t, there is a very small change in the positions of the synapses (although there can be a much larger change in momentum due to the larger masses of the synapse oscillators). As such, measuring the momentum through time yields the time averaged gradient of the effective potential U_{eff}, with some additional noise due to the Wiener process. Further, since the positions of the synapses have a negligible change during time t, the samples of the neurons used to compute the space average in U_{eff} is approximately time independent. For example, errors caused by changes in position would have very small effects and therefore can be ignored. This implies that the time averaged gradient of U_{eff} will approximately correspond to the averaged gradient of U_{eff}. Note that in practice, if only able to make discrete measurements of the momentum, a Monte-Carlo method may still be used to compute the time integral of the momentum as:

$$\frac{1}{t} {\int }_{0}^{t} {p}_{k} ( τ ) d τ \approx \frac{1}{T} {\sum }_{i = 1}^{T} {p}_{k} ( {t}_{i} )$$

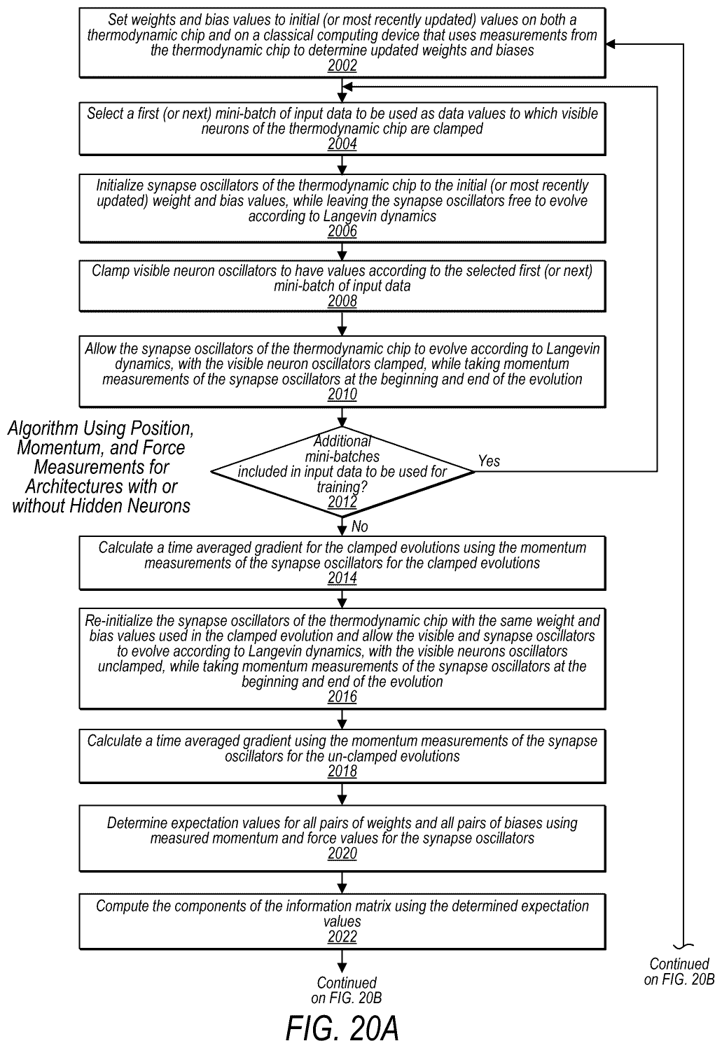

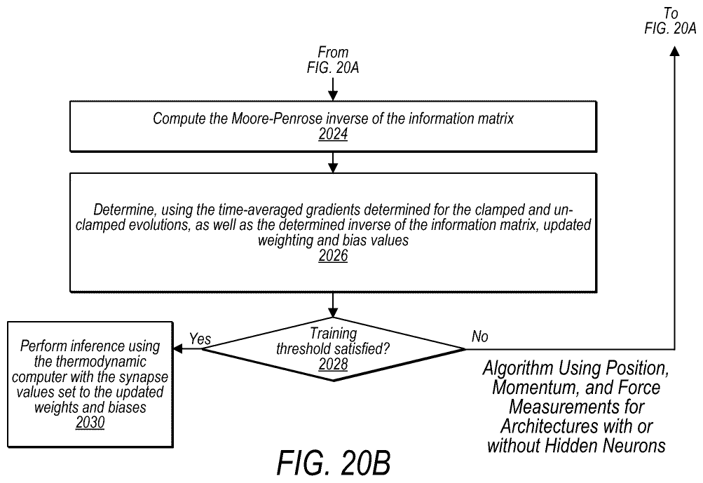

with 0≤tᵢ≤t. Recall that U_{eff} is the sum of Uₛ and U_{c}. Accordingly, a time averaged gradient can be determined for both the positive and negative phase terms through momentum (or position) measurements. Thus, given the initial position of a synapse oscillator, its contribution to the Hamiltonian can be computed on a classical computing device, such as an FPGA or ASIC as −∇_{q}_{ₖₗ}Uₛ. For example, algorithms for this learning protocol are given in FIGS. 19A-19B and 20A-20B. In these protocols, the following definition can be used:

$${𝔼}_{t} [ {\partial }_{k} {u}_{e f f} ( q , x , z ) ] ≡ \frac{{p}_{k} ( t ) - {p}_{k} ( 0 )}{t} + \frac{γ}{t} {\int }_{t}^{γ} {p}_{k} ( τ ) d τ$$

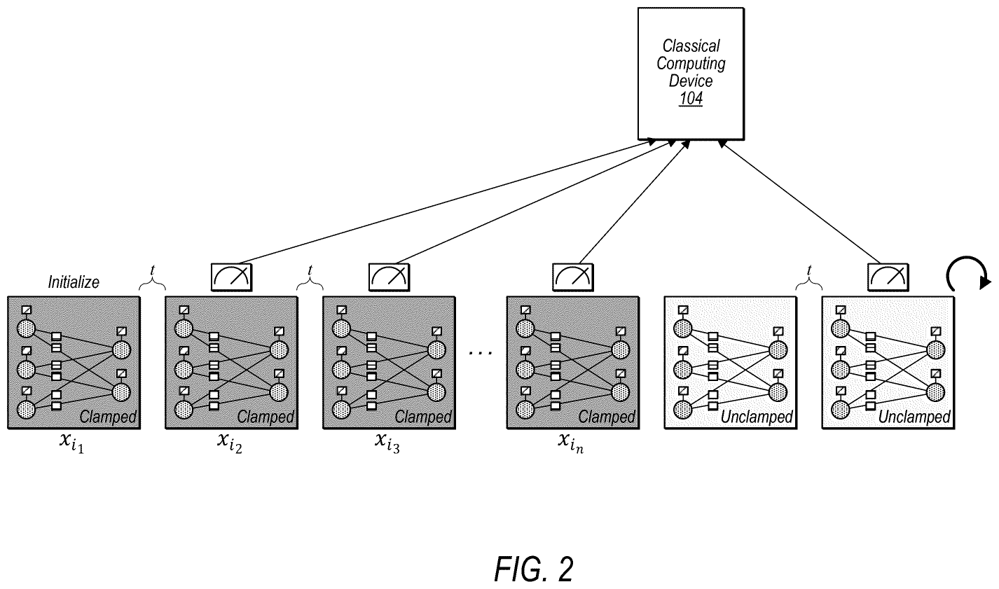

As such, [symbol] ₜ[∂ₖU_{eff}] is computed by measuring the k'th momentum of the synapses through time and computing the time average as described by the right-hand side of the above equation. Also, the time averaged momentum measurements can be combined into a single vector as

$${𝔼}_{t} [ {Δ}_{q} {U}_{e f f} ( q , x , z ) ] ≡ ( {𝔼}_{t} [ {\partial }_{1} {U}_{e f f} ( q , x , z ) ] , … , {𝔼}_{t} [ {\partial }_{S} {U}_{e f f} ( q , x , z ) ] )$$

where it is assumed that the thermodynamic chip has a total of S synapses. An illustration of this protocol is shown in FIG. 2. In some embodiments, in order to compute the potential for the log prior term (e.g., ∇_{q}_{ₖ}Uₛ), the measurement of the initial position qₖ may be used to compute the gradient directly on the FPGA. The above equations can be re-written in terms of position measurements as follows:

$${{p}_{k} ( t ) - {p}_{k} ( 0 ) + γ {m}_{k} ( {q}_{k} ( t ) - {q}_{k} ( 0 ) ) = - {\int }_{0}^{t} \frac{\partial {U}_{e f f} ( q , x , z )}{\partial {q}_{k}} \vert}_{τ} d τ + \sqrt{2 {m}_{k} γ {k}_{B} T} {\int }_{0}^{T} d {W}_{τ}$$

In such embodiments, the momentum can be approximated by taking the difference between positions with respect to time as follows:

$${p}_{k} ( t ) \approx {m}_{k} \frac{{q}_{k} ( t ) - {q}_{k} ( t - δ t )}{δ t}$$

$${p}_{k} ( 0 ) \approx {m}_{k} \frac{{q}_{k} ( δ t ) - {q}_{k} ( 0 )}{δ t}$$

where δt is a small time interval. Thus,

$${𝔼}_{t}^{( q )} [ {\partial }_{k} {u}_{e f f} ( q , x , z ) ] ≡ \frac{{p}_{k} ( t ) - {p}_{k} ( 0 )}{t} + \frac{γ {m}_{k}}{t} ( {q}_{k} ( t ) - {q}_{k} ( 0 ) )$$

Also,

$${𝔼}_{t}^{( q )} [ {∇}_{q} {U}_{e f f} ( q , x , z ) ] ≡ ( {𝔼}_{t}^{( q )} [ {\partial }_{1} {U}_{e f f} ( q , x , z ) ] , … , {𝔼}_{t}^{( q )} [ {\partial }_{S} {U}_{e f f} ( q , x , z ) ] ) .$$

In some embodiments, as an alternative to using momentum measurements as described above, position measurements of the synapse oscillators may be used.

In addition to calculating gradient terms as described above using position or momentum measurements, a time averaged expectation value (that is used in calculating the information matrix) may be computed using measurements of position, momentum, and/or force of the synapse oscillators. For example, the time averaged version of the expectation value used in the BKM metric, (as discussed above) is given by:

$${𝔼}_{( x ) ∼ {p}_{θ} ( x )} [ {\partial }_{{θ}_{j}} {ℰ}_{θ} ( x ) {\partial }_{{θ}_{k}} {ℰ}_{θ} ( x ) ] - {𝔼}_{( x ) ∼ {p}_{θ} ( x )} [ {\partial }_{{θ}_{j}} {ℰ}_{θ} ( x ) ] {𝔼}_{( y ) ∼ {p}_{θ} ( y )} [ {\partial }_{{θ}_{k}} {ℰ}_{θ} ( y ) ]$$

In some embodiments, sampling may be used to compute the averages, where the sampling occurs over the Gibbs distribution of the joint synapse-neuron system. For example, focusing on the momentum for the synapses pᵢ and pⱼ the above equation can be written, for example as:

$$\frac{1}{t} {\int }_{0}^{t} \frac{d {p}_{i} ( τ )}{d τ} \frac{{dp}_{j} ( τ )}{d τ} d τ + \frac{γ}{t} ( {p}_{i} ( t ) {p}_{j} ( t ) - {p}_{i} ( 0 ) {p}_{j} ( 0 ) ) + \frac{{γ}^{2}}{t} {\int }_{0}^{t} {p}_{i} ( τ ) {p}_{j} ( τ ) d τ = \frac{1}{t} {\int }_{0}^{t} \frac{\partial H}{{\partial }_{{q}_{i}}} \frac{\partial H}{{\partial }_{{q}_{j}}} d τ - \frac{\sqrt{2 {m}_{j} γ {k}_{B} T}}{t} {\int }_{0}^{t} \frac{\partial H}{{\partial }_{{q}_{i}}} d {W}_{j} ( τ ) - \frac{\sqrt{2 {m}_{i} γ {k}_{B} T}}{t} {\int }_{0}^{t} \frac{\partial H}{{\partial }_{{q}_{j}}} d {W}_{i} ( τ ) + \frac{1}{t} {\int }_{0}^{t} \frac{d {W}_{i} ( τ )}{d τ} \frac{d {W}_{j} ( τ )}{d τ} d τ$$

Also, as discussed above, the momentum equation of motion for a single synapse can be written as:

$${{p}_{k} ( t ) - {p}_{k} ( 0 ) + γ {\int }_{0}^{t} {p}_{k} ( τ ) d τ = - {\int }_{0}^{t} \frac{\partial H}{\partial {q}_{k}} \vert}_{τ} d τ + \sqrt{2 {m}_{k} γ {k}_{B} T} {\int }_{0}^{T} d {W}_{τ}$$

Thus, by measuring the momentum degree of freedom of the synapses through time the time averaged gradient ∂H/∂q can be calculated. Also, by measuring both the force (e.g., dp/dt) and momentum of synapse degrees of freedom through time, the time average of

$$\frac{1}{t} {\int }_{0}^{t} \frac{\partial H}{{\partial }_{{q}_{i}}} \frac{\partial H}{{\partial }_{{q}_{j}}}$$

dt can be obtained. Also, the time averaged value of the second term of the re-written BKM metric equation (above) can be computed by measuring the momentum degrees of freedom through time. Also, the integrals included in the BKM metric equation (above) can be approximated as follows:

$$\frac{1}{t} {\int }_{0}^{t} \frac{d {p}_{i} ( τ )}{d τ} \frac{{dp}_{j} ( τ )}{d τ} d τ \approx \frac{1}{T} {\sum }_{k = 1}^{T} \frac{d {p}_{i} ( {t}_{k} )}{dt} \frac{{dp}_{i} ( {t}_{k} )}{dt} ( e . g . force ) ; and$$

$${\int }_{0}^{t} {p}_{i} ( τ ) {p}_{j} ( τ ) d τ \approx \frac{1}{T} {\sum }_{k = 1}^{T} {p}_{i} ( {t}_{k} ) {p}_{j} ( {t}_{k} )$$

This allows for the implementation of a protocol for performing natural gradient descent that determines the elements of the information matrix using oscillator measurements of synapse oscillators, such as force and momentum measurements, or alternatively position measurements, wherein position measurements measured over time are used to approximate momentum and/or force measurements. Also, momentum measurements taken over time may be used to approximate force measurements. For example, the expectation values used in the information matrix may be defined as

$${𝔼}_{t} [ {\partial }_{k} {U}_{e f f} ( q , x , z ) ] ≡ \frac{{p}_{k} ( 0 ) - {p}_{k} ( t )}{t} - \frac{γ}{t} {\int }_{0}^{t} {p}_{k} ( τ ) d τ .$$

As such, [symbol] ₜ[∂ₖU_{eff}] can be computed by measuring the k'th momentum of the synapses through time and computing the time average, using the above equation. These time averaged momentum measurements can be combined into a single vector:

$${𝔼}_{t} [ {Δ}_{q} {U}_{e f f} ( q , x , z ) ] ≡ ( {𝔼}_{t} [ {\partial }_{1} {U}_{e f f} ( q , x , z ) ] , … , {𝔼}_{t} [ {\partial }_{S} {U}_{e f f} ( q , x , z ) ] )$$

Also:

$${𝔼}_{t} [ {\partial }_{i} U ( q , x , z ) {\partial }_{j} U ( q , x , z ) ] = \frac{1}{t} {\int }_{0}^{t} \frac{d {p}_{i} ( τ )}{d τ} \frac{{dp}_{j} ( τ )}{d τ} d τ + \frac{γ}{t} ( {p}_{i} ( t ) {p}_{j} ( t ) - {p}_{i} ( 0 ) {p}_{j} ( 0 ) ) + \frac{{γ}^{2}}{t} {\int }_{0}^{t} {p}_{i} ( τ ) {p}_{j} ( τ ) d τ .$$

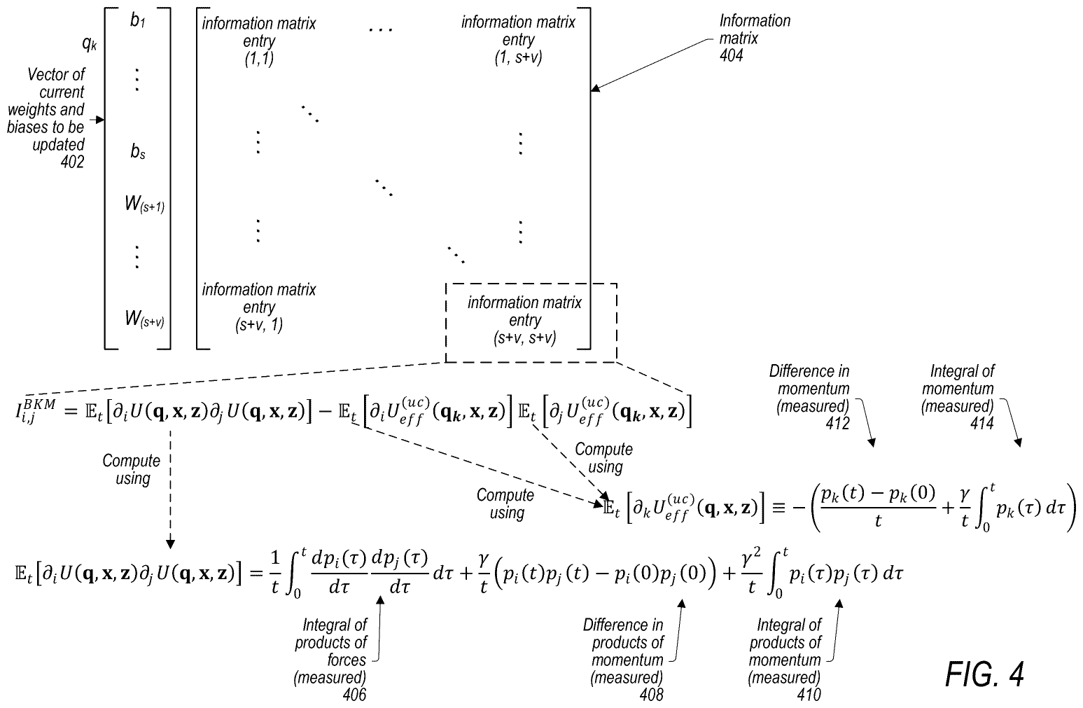

Note that FIG. 4 further explains how the above terms are computed using measured forces and momentums (or alternatively, positions that are used to approximate momentum and force or momentum measurements that are used to approximate force measurements).

For example, in some embodiments, a position measurement-based protocol can be used to perform natural gradient descent. Using the fact that pₖ(t)=mₖdqₖ(t)/dt, the momentum and force terms can be approximated as:

$${p}_{k} ( t ) \approx {m}_{k} \frac{{q}_{k} ( t ) - {q}_{k} ( t - δ t )}{δ t} ( e . g . , momentum approximation ) ; and$$

$$\frac{d {p}_{k} ( t )}{dt} \approx \frac{{m}_{k}}{δ {t}^{2}} ( {q}_{k} ( t ) - 2 {q}_{k} ( t - δ t ) + {q}_{k} ( t - 2 δ t ) ) ( e . g . , force approximation ) .$$

Thus, in some embodiments, momentum can be approximated by two position measurements separated by a small time interval (e.g., δt). Also, force can be approximated by three position measurements, each separated by respective small time intervals, δt. Alternatively, force can be approximated by two momentum measurements separated by a small time interval δt.

For example, the integrals included in the equation for determining the BKM metric can be approximated as follows:

$$\frac{1}{t} {\int }_{0}^{t} \frac{d {p}_{i} ( τ )}{d τ} \frac{d {p}_{j} ( τ )}{d τ} d τ \approx \frac{{m}_{i} {m}_{j}}{T δ {t}^{4}} {\sum }_{k = 1}^{T} ( {q}_{i} ( {t}_{k} ) - 2 {q}_{i} ( {t}_{k} - δ t ) + {q}_{i} ( {t}_{k} - 2 δ t ) ) ( {q}_{j} ( {t}_{k} ) - 2 {q}_{j} ( {t}_{k} - δ t ) + {q}_{j} ( {t}_{k} - 2 δ t ) )$$

$$and$$

$$\frac{1}{t} {\int }_{0}^{t} {p}_{i} ( τ ) {p}_{j} ( τ ) d τ \approx \frac{{m}_{i} {m}_{j}}{T δ {t}^{2}} {\sum }_{k = 1}^{T} ( {q}_{i} ( {t}_{k} ) - 2 {q}_{i} ( {t}_{k} - δ t ) ) ( {q}_{j} ( {t}_{k} ) - 2 {q}_{j} ( {t}_{k} - δ t ) ) .$$

Using the above approximations, the expectation values can be written in terms of position measurements, such as:

$${𝔼}_{t}^{( q )} [ {\partial }_{k} {U}_{e f f} ( q , x , z ) ] \approx \frac{{m}_{k}}{t δ t} [ {q}_{k} ( t ) - {q}_{k} ( t - δ t ) - ( {q}_{k} ( δ t ) - {q}_{k} ( t 0 ) ) ] + \frac{{m}_{k} γ}{t} ( {q}_{k} ( δ t ) - {q}_{k} ( t 0 ) )$$

$$and$$

$${𝔼}_{t}^{( q )} [ {Δ}_{q} U ( q , x , z ) ] ≡ ( {𝔼}_{t}^{( q )} [ {\partial }_{1} U ( q , x , z ) ] , … , {𝔼}_{t}^{( q )} [ {\partial }_{S} {U}_{e f f} ( q , x , z ) ] ) .$$

Protocols for both the first technique using momentum and force measurements (or approximations), and the second technique using pure position measurements are shown in FIGS. 19A-19B and FIGS. 20A-20B.

Broadly speaking, classes of algorithms that may benefit from implementation using a thermodynamic chip include those algorithms that involve probabilistic inference. Such probabilistic inferences (which otherwise would be performed using a CPU or GPU) may instead be delegated to the thermodynamic chip for a faster and more energy efficient implementation. At a physical level, the thermodynamic chip harnesses electron fluctuations in superconductors coupled in flux loops to model Langevin dynamics. In some embodiments, architectures such as those described herein may resemble a partial self-learning architecture, wherein classical computing device(s) (e.g., a FPGA, ASIC, etc.) may be relied upon only to perform simple tasks such as multiplying, adding, subtracting, and/or integrating measured values and performing other non-compute intensive operations in order to implement a learning algorithm (e.g., the natural gradient descent algorithm).

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime slightly above 0 Kelvin, wherein thermodynamic effects cannot be ignored. For example, some thermodynamic chips may be operated within the milli-Kelvin range, and/or at 2, 3, 4, etc. degrees Kelvin. The term thermodynamic chip also indicates that the thermal equilibrium dynamics of the neurons are used to perform computations. In some embodiments, temperatures less than 15 Kelvin may be used. Though other temperatures ranges are also contemplated. This also, in some contexts, may be referred to as analog stochastic computing. In some embodiments, the temperature regime and/or oscillation frequencies used to implement the thermodynamic chip may be engineered to achieve certain statistical results. For example, the temperature, friction (e.g., damping) and/or oscillation frequency may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a thermodynamic chip may be used to solve variational algorithms and perform learning tasks and operations.

FIG. 1 is high-level diagram illustrating a process of determining weights and biases to be used in a Bayesian algorithm, wherein the weights and biases are determined using measurement values for synapse oscillators of a thermodynamic chip, and wherein visible neuron oscillators of the thermodynamic chip are used to implement, at least in part, the Bayesian algorithm, according to some embodiments.

As shown in FIG. 1, in a first evolution, visible neurons of thermodynamic chip 102 may be clamped to input data. For example, as further shown in FIG. 2, multiple mini-batches of input data may be clamped to visible neurons for multiple evolutions used to generate a first set of measurements used to compute a positive phase term. For example, the measurements may be used by classical computing device 104 to compute the positive phase term.

Also, in a second (or other subsequent) evolution, the visible neurons may remain unclamped, such that the visible neuron oscillators are free to evolve along with the synapse oscillators during the second (or other subsequent) evolution. Measurements may also be taken and used by the classical computing device 104 to compute a negative phase term.

Also, in addition to computing the positive and negative phase terms, measurements taken during the unclamped evolution may be used to determine elements of the information matrix, for example using the equation discussed above and further shown in FIG. 4.

Additionally, the positive and negative phase terms computed based on the first and second sets of measurements (e.g., clamped measurements and un-clamped measurements) along with the determined information matrix may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the model may transition into a mode of performing inferences using the learned weights and biases. If not sufficiently trained, the process may continue with additional iterations of determining updated weights and biases.

FIG. 2 is a high-level diagram illustrating synapse oscillator measurements being taken for evolutions of the thermodynamic chip, wherein the visible neuron oscillators of the thermodynamic chip are clamped to mini-batches of input training data during evolutions for which a first set of measurements are taken, and wherein the visible neuron oscillators are left un-clamped during an additional one or more evolutions for which a second set of measurements are taken, according to some embodiments.

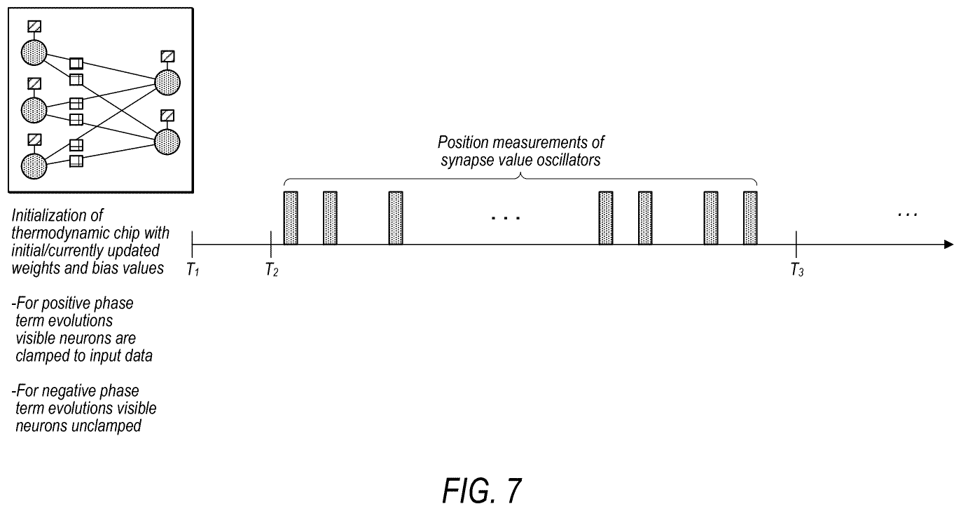

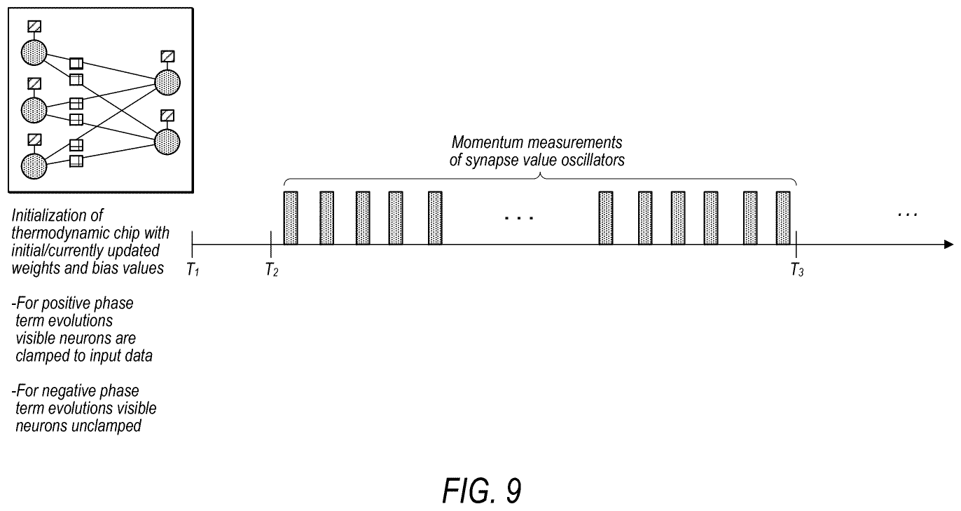

The process shown in FIG. 2 corresponds with the algorithms shown in FIGS. 19A-19B and FIGS. 20A-20B. At each of the shown evolutions, the thermodynamic chip is initialized with a set of synapse values corresponding to a current set of weights and biases (for which updates are being determined). For each mini-batch of a set of input training data, the visible neurons are clamped to corresponding elements of the mini-batch of training data. While the visible neuron oscillators are clamped, the synapse oscillators are allowed to evolve according to Langevin dynamics, e.g., they evolve for a time t (as shown in FIG. 2). During the evolution, the momentum (or position) of the synapse oscillators is measured, such as shown in FIGS. 6 and 8. Also, during the un-clamped phase, the weights and biases are also initialized to the current weight and bias values for which an update is being determined. However, in the un-clamped phase both the visible neuron oscillators and the synapse oscillators are allowed to evolve according to Langevin dynamics. For the un-clamped phase, during the evolution, the position, momentum, and/or force are measured, such as shown in FIGS. 6, 8, and 10. After the evolution, the gradient for the un-clamped phase is computed on the classical computing device 104 based on the received measurements. The gradient for the clamped phase (e.g., log prior term) may also be computed on the classical computing device 104 as −∇_{q}_{₀}Uₛ(q₀). Additionally, the elements of the information matrix (e.g. expectation values) are computed on the classical computing device 104. New weights and biases are then computed on the classical computing device using the determined gradients and information matrix. These newly computed updated weights and biases may then be used to initialize another iteration of learning.

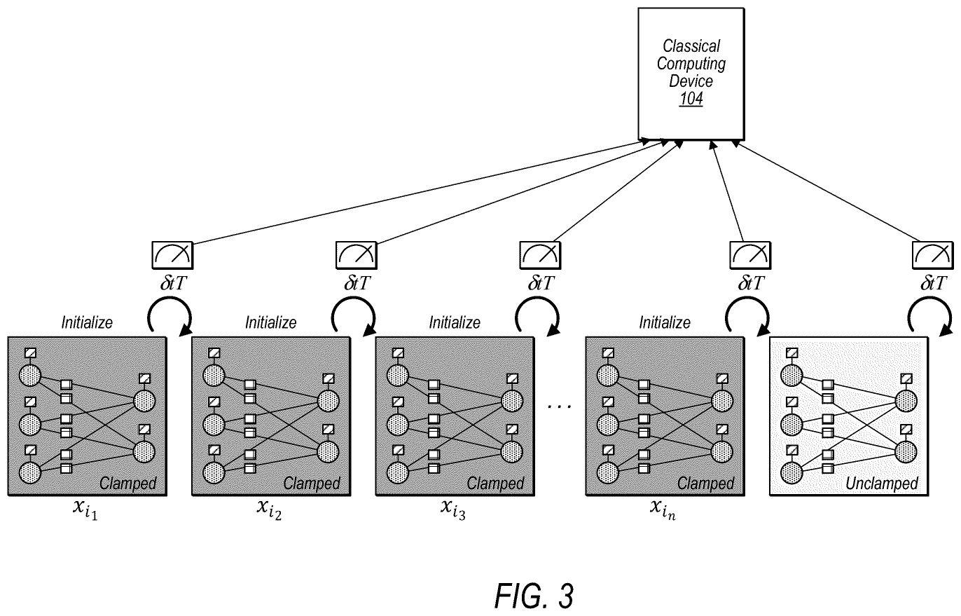

FIG. 3 is a high-level diagram illustrating synapse oscillator measurements being taken for evolutions of the thermodynamic chip, wherein a plurality of the measurements are taken at a faster time scale than a time scale required for the synapse oscillators to reach a thermal equilibrium, and wherein the faster measurements of the synapse oscillators are taken during evolutions of both a clamped and un-clamped configuration of thermodynamic chip, according to some embodiments.

In some embodiments, fast measurements at a time scale faster than a time scale in which the synapse oscillators reach thermal equilibrium may be taken. For example, FIG. 3 shows measurements being taken at a faster pace (e.g., at each ST interval), wherein ST is smaller than the time required for the synapse oscillators to reach thermal equilibrium.

FIG. 4 illustrates an example information matrix that is used in determining updated weight and biases values using a natural gradient descent technique, wherein the components of the information matrix are determined using synapse oscillator measurement results and simple integration, multiplication, and subtraction operations performed by a classical computing device, according to some embodiments.

For example, as discussed above, the information matrix (e.g. information matrix 404) may correspond to elements of a vector of current weights and biases (e.g. current weights and biases vector 402). Also, as shown in the above equations, the new weights may be calculated using an equation involving the Moore-Penrose pseudo inverse of the information matrix (e.g. I⁺). As shown in FIG. 4, each of the information matrix entries may be calculated using the equation shown in FIG. 4. Wherein the first term is computed using the equation below that can be calculated from measured results and wherein the second and third terms can also be calculated from measured results. For example, an integral of products of measured (or approximated) forces (406) along with differences in products of measured momentums (408) and integral of products of measured momentums (410) may be used to compute the first term of the BKM metric equation. Additionally, both the second and third terms of the BKM metric equation may be computed using the equation as shown in FIG. 4, wherein the difference in measured momentums (412) and integral of measured momentums (414) are used in calculating the second and third terms of the BKM metric equation. Also, as discussed above, in some embodiments, sets of two position measurements may be used to approximate momentum measurements and sets of three position measurements may be used to approximate force measurements. Also, sets of two momentum measurements may be used to approximate force measurements. Thus, in some embodiments the elements of the information matrix 404 may be computed purely using position measurements.

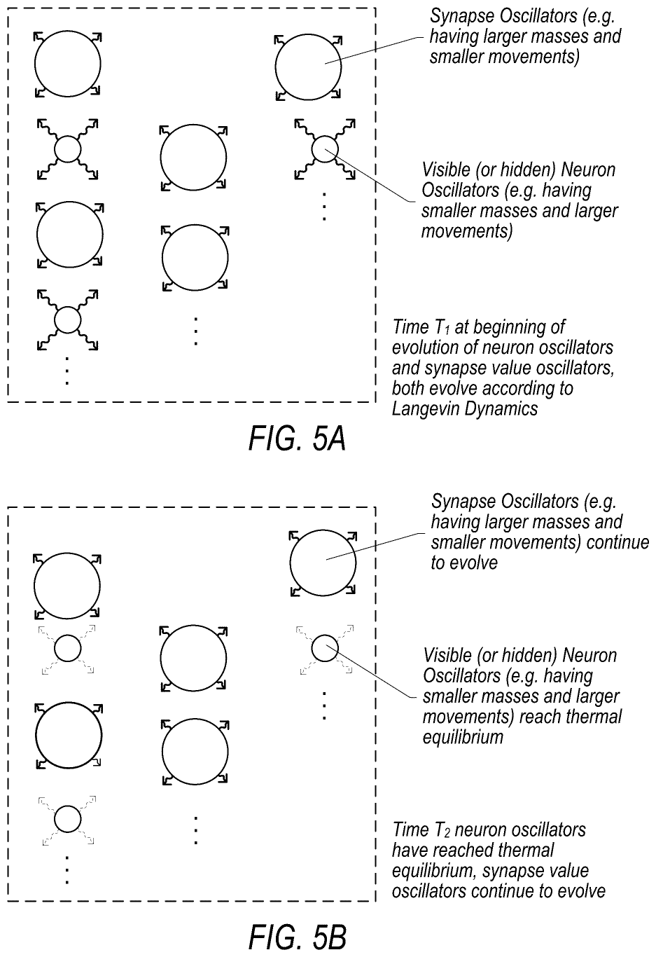

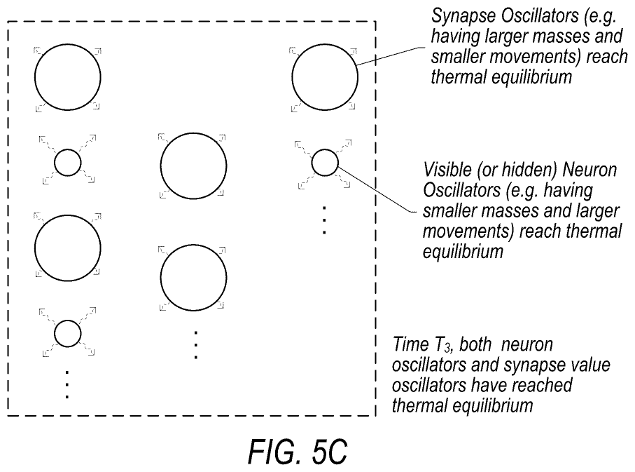

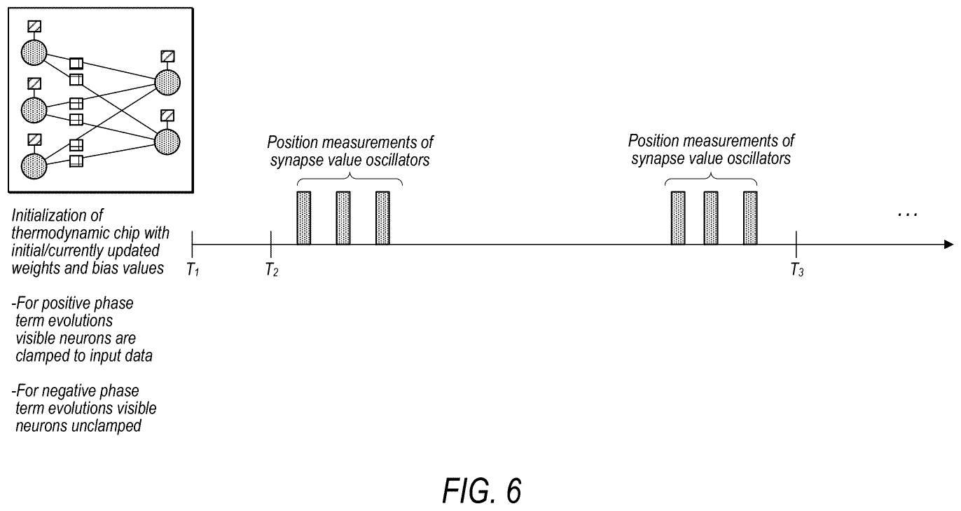

FIG. 5A is an illustrative diagram showing relative masses and motions of the synapse oscillators and neuron oscillators of a thermodynamic chip at a time T₁ corresponding to an initial portion of an evolution of the thermodynamic chip, according to some embodiments.

At a time T₁, for example at a beginning of an evolution of the un-clamped phase, both visible neuron oscillators (and if present, hidden neuron oscillators) along with synapse oscillators evolve according to Langevin dynamics. In FIG. 5A the sizes of the circles are intended to indicate relative masses of the oscillators, wherein the synapse oscillators have larger masses than the visible neuron oscillators. Accordingly, the synapse oscillators have smaller displacements (as represented by the smaller squiggly arrows) than the visible neuron oscillators. Also, due to the larger masses, the synapse oscillators take a longer time to reach thermal equilibrium than the visible neuron oscillators.

FIG. 5B is an illustrative diagram showing the relative masses and motions of the synapse oscillators and the neuron oscillators of the thermodynamic chip at a time T₂ corresponding to a point in time in the evolution wherein the neuron oscillators have reached a thermal equilibrium, but the synapse oscillators have not yet reached thermal equilibrium and continue to evolve, according to some embodiments.

At time T₂ the smaller (in mass terms) visible neuron oscillators have reached thermal equilibrium, but the larger (in mass terms) synapse oscillators continue to evolve and have not yet reached thermal equilibrium. Note that even after the visible neuron oscillators reach thermal equilibrium, they may continue to move (e.g. change position). However, at thermal equilibrium, their motion is described by the Boltzmann distribution.

FIG. 5C is an illustrative diagram showing the relative masses and motions of the synapse oscillators and the neuron oscillators of the thermodynamic chip at a time T₃ corresponding to a point in time in the evolution wherein the neuron oscillators and the synapse oscillators have reached thermal equilibrium, according to some embodiments.

At time T₃ both the visible neuron oscillators and the synapse oscillators have reached thermal equilibrium. As discussed above, at thermal equilibrium, the visible neuron oscillators and the synapse oscillators will continue to move with their motion described by the Boltzmann distribution. Thus, the thin dotted lines in FIGS. 5A-5C indicate motion at thermal equilibrium, whereas the darker solid lines indicate motion that varies with time as the visible neuron oscillators and the synapse oscillators evolve, respectively, from initialization states to respective thermal equilibrium states.

FIG. 6 illustrates an example of position measurements being taken of the synapse oscillators between time T₂ and time T₃, wherein a set of position measurements of the synapse oscillators are taken sequentially close in time to one another shortly after the neuron oscillators have reached thermal equilibrium and another set of position measurements of the synapse oscillators are taken sequentially close in time to one another sometime later, which may be shortly before the synapse oscillators reach thermal equilibrium, according to some embodiments.

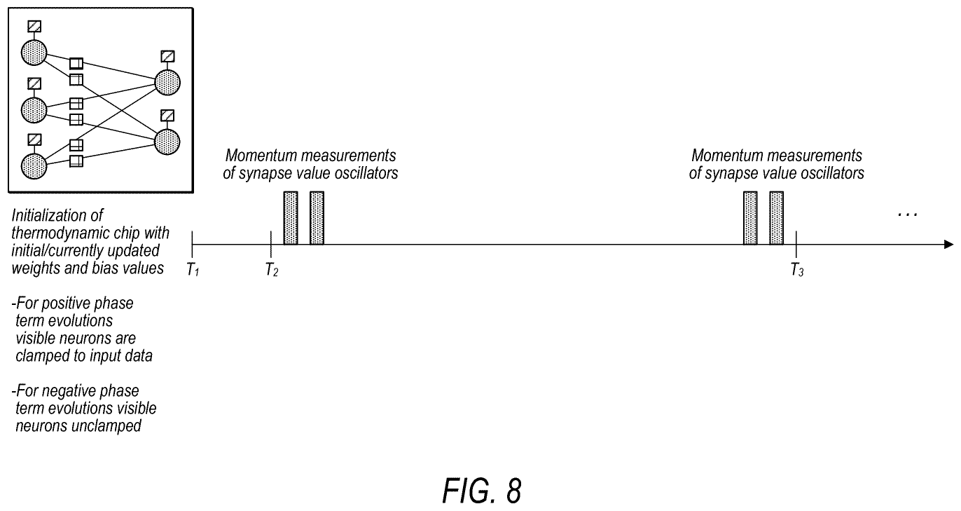

In some embodiments, position measurements may be used in a learning algorithm, such as shown in FIGS. 19A-19B. In such embodiments, the thermodynamic chip (and the classical computing device) may be initialized with an initial set of weights and biases (or a most recently updated set of weights and biases resulting from a prior round of learning). For each evolution, e.g., both the clamped and the un-clamped evolutions, position measurements may be taken as shown in FIG. 6. For example, slightly after time 2 (when the visible neuron oscillators reach thermal equilibrium) a set of position measurements may be taken in rapid succession. Because mass of the synapse oscillators is constant and known, the change in position with respect to time (e.g., velocity) of the synapse oscillators (along with the known masses) can be used to approximate momentum. This approach is applicable when the evolution of the synapse oscillators is approximately linear. In circumstances wherein the synapse oscillator evolution cannot be approximated as linear, a different position measuring regime as further discussed in FIG. 7, may be used.

In a similar manner as described above with respect to the set of position measurements taken in rapid succession slightly after time 2, a rapid set of position measurements may be taken some time later, such as shortly before time 3, e.g., towards the end of the evolution and prior to the synapse oscillators reaching thermal equilibrium. Also, in some embodiments, the second set of position measurements may be taken in rapid succession at another time subsequent to when the first set of position measurements were taken. For example, sufficient spacing to allow for an accurate time average to be compute is sufficient, and it is not necessary to wait until the synapse oscillators reach thermal equilibrium. Though, such an approach is also a valid implementation. Thus, in some embodiments, T₃ may occur well before an amount of time sufficient for the synapse oscillators to reach thermal equilibrium has elapsed. Also, in some embodiments, wherein it is known that the oscillator degrees of freedom representing the synapse oscillators are in the linear regime, the requirement that position measurements be taken in rapid succession can be relaxed. For example, if changes in position are linear (e.g. occurring at a near constant velocity) then arbitrary spacing of the position measurements will result in equivalent computed momentum values.

FIG. 7 illustrates an example of position measurements being taken of the synapse oscillators between time T₂ and time T₃, wherein multiple sets of position measurements of the synapse oscillators are taken sequentially close in time to one another between time T₂ (when the neuron oscillators reach thermal equilibrium) and time T₃ (when the synapse oscillators reach thermal equilibrium), according to some embodiments. Also, in some embodiments, T₃ may occur well before an amount of time required for the synapse oscillators to reach thermal equilibrium.

In some embodiments, instead of taking a set of position measurements slightly after time T₂ and again slightly before time T₃ and using these sets of position measurements to determine a time averaged gradient, a measurement scheme as shown in FIG. 6 may be employed wherein a larger quantity of position measurements are taken at each time interval δt (as shown in FIG. 3). These position measurements may be used in an integration to determine a time averaged gradient, in some embodiments. In some embodiments, for example in which the position degrees of freedom on the thermodynamic chip that represent the synapse values are in a linear regime, the requirement that the position measurements be taken close in time may be relaxed. For example, if change in position of the synapse oscillators has a near constant slope, then the velocity of the synapse oscillators can be considered to be constant, in which case position measurements taken at arbitrary time spacings would result in comparable results as position measurements taken close in time to one another. However, for embodiments wherein the position degrees of freedom are not in the linear regime, then the close in time sequencing of the measurements may be enforced to ensure accurate time-averaged momentum values can be calculated from the position measurements.

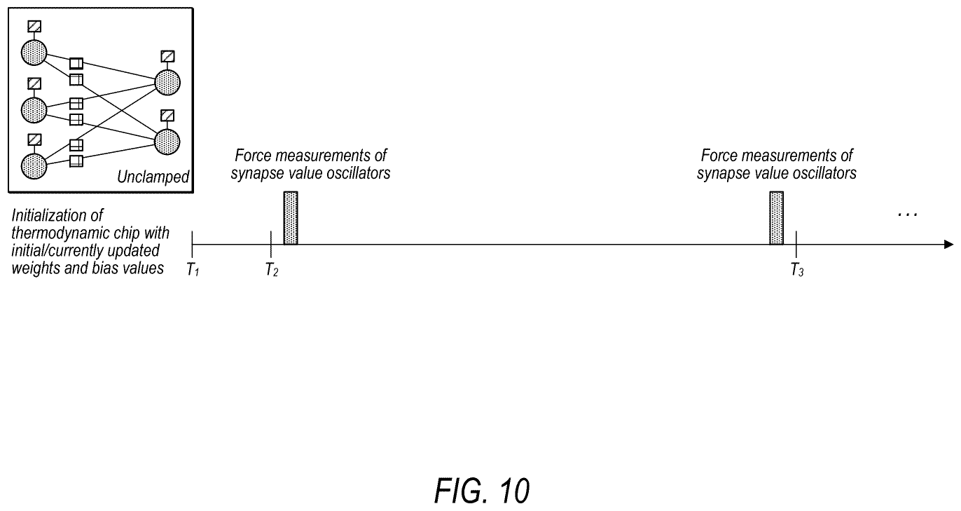

FIG. 8 illustrates an example of momentum measurements being taken of the synapse oscillators between time T₂ and time T₃, wherein momentum measurements of the synapse oscillators are taken shortly after the neuron oscillators have reached thermal equilibrium and momentum measurements of the synapse oscillators are taken some time later, which may occur shortly before the synapse oscillators reach thermal equilibrium or before, according to some embodiments. This approach is applicable when the evolution of the synapse oscillators is approximately linear. In circumstances wherein the synapse oscillator evolution cannot be approximated as linear, a different momentum measuring regime as further discussed in FIG. 9, may be used.

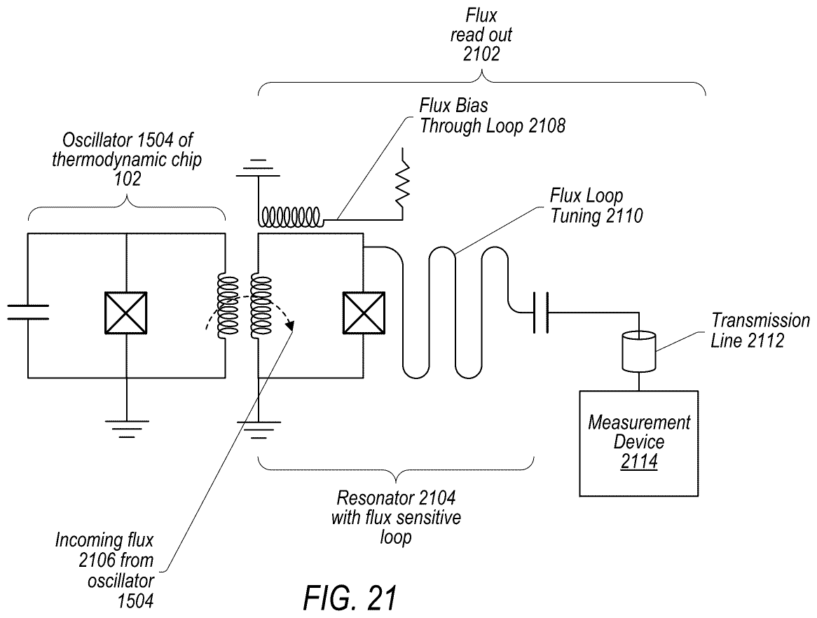

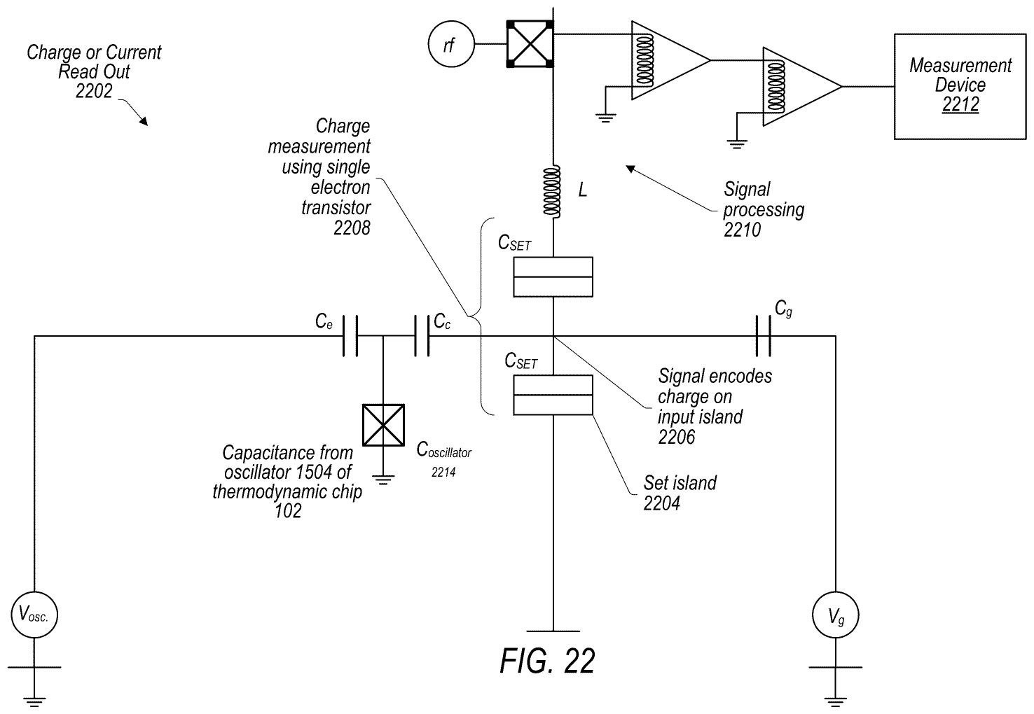

In some embodiments, instead of making position measurements close in time to one another at the beginning and end of the period between T₂ and T₃ as shown in FIG. 6, momentum may be measured directly. For example, a flux-read out device as shown in FIG. 21 may be used to measure position (as described above), whereas a charge measurement device, as shown in FIG. 22, may be used to measure momentum directly. Also, force can be approximated from a set of three position measurements or a set of two momentum measurements. For example, the following formula can be used to infer force from a set of measured momentums that are measured close to one another in time.

$${F}_{k} ( t ) \approx \frac{{p}_{k} ( t ) - {p}_{k} ( t - δ t )}{δ t}$$

In some embodiments the momentum measurement taken at the beginning of the period between T₂ and T₃ and the momentum measurement taken near the end of the period between T₂ and T₃ may be used to calculate a time averaged gradient and/or elements of an information matrix. While FIG. 8 only shows two momentum measurements, in some embodiments more than two momentum measurements may be taken. For example, if momentum evolves linearly, then two momentum measurements are sufficient to determine a time-averaged gradient. However, if momentum evolves non-linearly, then more momentum measurements may need to be taken.

FIG. 9 illustrates an example of multiple momentum measurements being taken of the synapse oscillators between time T₂ (when the neuron oscillators reach thermal equilibrium) and time T₃, according to some embodiments.

In some embodiments, multiple momentum measurements may be taken in the period between T₂ and T₃. For example, as shown in FIG. 9. These momentum measurements may be used to determine a gradient for use in determining updated weights and biases. Also, these momentum values may be used to determine elements of an information matrix.

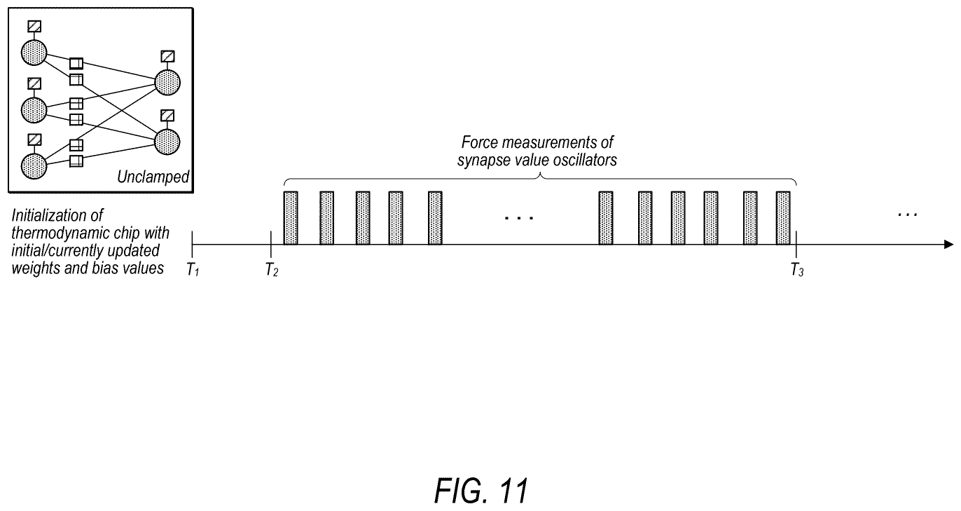

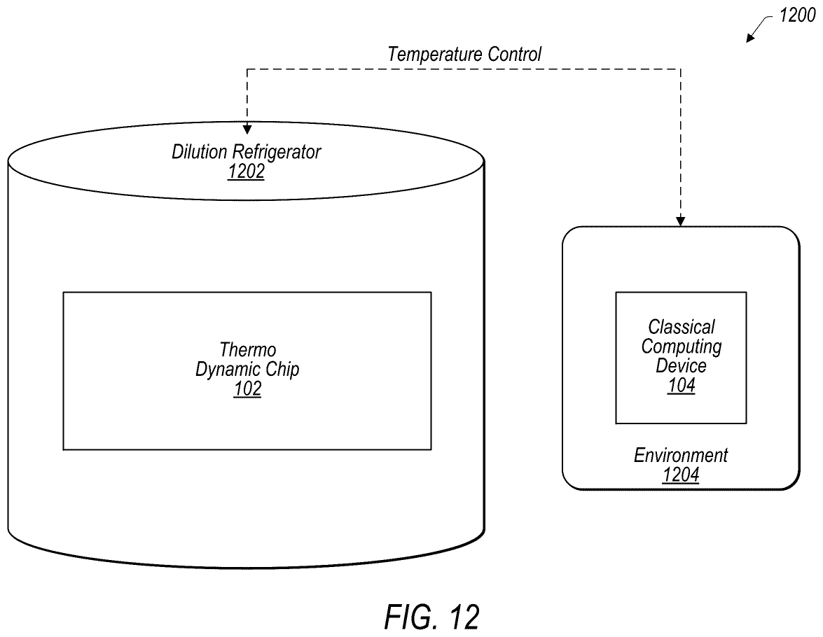

FIG. 10 illustrates an example of force measurements being taken of the synapse oscillators between time T₂ and time T₃, wherein force measurements of the synapse oscillators are taken shortly after the neuron oscillators have reached thermal equilibrium and force measurements of the synapse oscillators are taken some time later, which may occur shortly before the synapse oscillators reach thermal equilibrium or before, according to some embodiments. This approach is applicable when the evolution of the synapse oscillators is approximately linear. In circumstances wherein the synapse oscillator evolution cannot be approximated as linear, a different force measuring regime as further discussed in FIG. 11, may be used.

In some embodiments, instead of making position measurements close in time to one another at the beginning and end of the period between T₂ and T₃ as shown in FIG. 6, force may be measured directly. For example, a flux-read out device as shown in FIG. 21 may be used to measure position (as described above), whereas a charge measurement device, as shown in FIG. 22, may be used to measure momentum directly and approximate force measurements. In some embodiments the force measurement taken at the beginning of the period between T₂ and T₃ and the force measurement taken near the end of the period between T₂ and T₃ may be used to calculate elements of an information matrix. While FIG. 10 only shows two force measurements, in some embodiments more than two force measurements may be taken. For example, if force evolves linearly, then two force measurements are sufficient to determine a time-averaged expectation value included in an information matrix. However, if force evolves non-linearly, then more force measurements may need to be taken.

FIG. 11 illustrates an example of multiple force measurements being taken of the synapse oscillators between time T₂ (when the neuron oscillators reach thermal equilibrium) and time T₃, according to some embodiments.

In some embodiments, multiple force measurements may be taken in the period between T₂ and T₃. For example, as shown in FIG. 11. These force measurements may be used to determine a time weighted expectation value used in determining elements of an information matrix used in determining updated weights and biases.

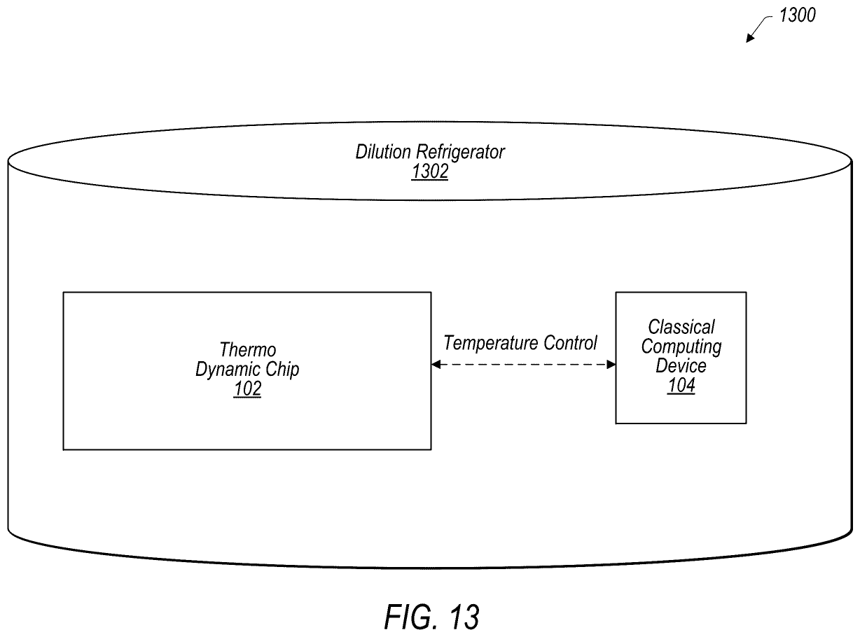

FIG. 12 is high-level diagram illustrating an example architecture of a self-learning neuro-thermodynamic computer comprising a thermodynamic chip included in a dilution refrigerator and coupled to a classical computing device in an environment external to the dilution refrigerator, according to some embodiments.

In some embodiments, a neuro-thermodynamic computing system 1200 (as shown in FIG. 12) may be used to implement the various embodiments shown in FIGS. 1-11 and may include a thermodynamic chip 102 placed in a dilution refrigerator 1202. In some embodiments, classical computing device 104 may control temperature for dilution refrigerator 1202, and/or perform other tasks, such as helping to drive a pulse drive to change respective hyperparameters of the given system and/or perform measurements, such as those shown in FIGS. 1-11. Also, the classical computing device 104 may perform other simple computing operations, such as are needed to determine updated weights and biases based a first set of measurements of synapse oscillators subsequent to (or during) a clamped evolution and based on a second set of measurements of synapse oscillators subsequent to (or during) an un-clamped evolution.

In some embodiments, classical computing device 104 may include one or more devices such as a field-programmable gate array (FPGA), an application specific integrated circuit (ASIC), and/or other devices that may be configured to interact and/or interface with a thermodynamic chip within the architecture of neuro-thermodynamic computer 1200. For example, such devices may be used to tune hyperparameters of the given thermodynamic system, etc. as well as perform part of the calculations necessary to determine updated weights and biases.

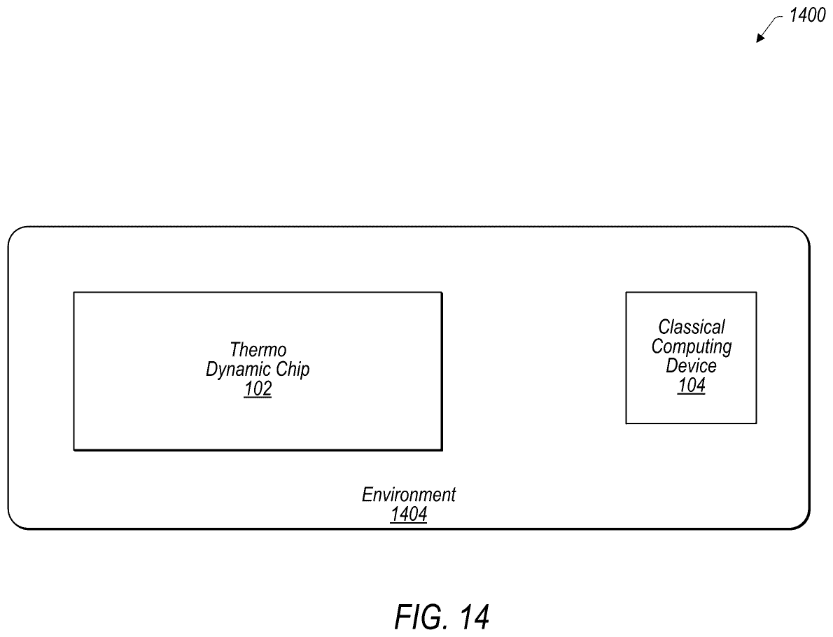

FIG. 13 is high-level diagram illustrating an example neuro-thermodynamic computer comprising a thermodynamic chip included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 1300, may be included in a dilution refrigerator with the thermodynamic chip. For example, neuro-thermodynamic computer 1300 includes both thermodynamic chip 102 and classical computing device 104 in dilution refrigerator 1302.

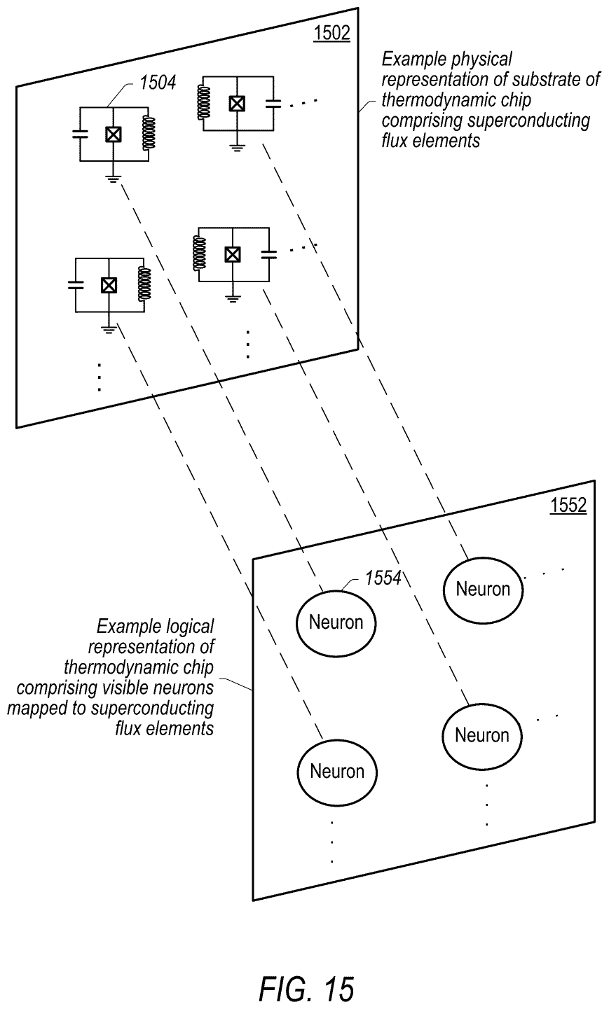

FIG. 14 is high-level diagram illustrating an example neuro-thermodynamic computer comprising a thermodynamic chip coupled to a classical computing device in an environment other than a dilution refrigerator, according to some embodiments.

Also, in some embodiments, a neuro-thermodynamic computer, such as neuro-thermodynamic computer 1400, may be implemented in an environment other than a dilution refrigerator. For example, neuro-thermodynamic computer 1400 includes thermodynamic chip 102 and classical computing device 104, in environment 1404. In some embodiments, environment 1404 may be temperature controlled and, the classical computing device (or other device) may control the temperature of environment 1404 in order to achieve a given level of evolution according to Langevin dynamics.

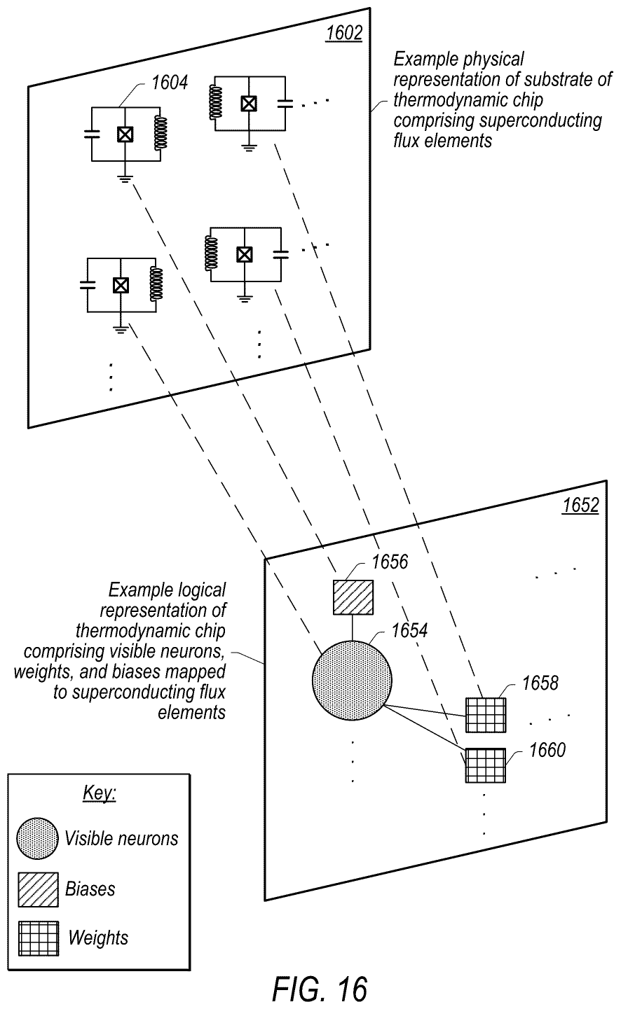

FIG. 15 is a high-level diagram illustrating oscillators included in a substrate of the thermodynamic chip and mapping of the oscillators to logical neurons of the thermodynamic chip, according to some embodiments.

In some embodiments, a substrate 1502 may be included in a thermodynamic chip, such as any one of the thermodynamic chips described above, such as thermodynamic chip 102. Oscillators 1504 of substrate 1502 may be mapped in a logical representation 1552 to neurons 1554, as well as weights and biases (shown in FIG. 16). In some embodiments, oscillators 1504 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1504. In some embodiments, the oscillators 1504 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 15 for oscillator 1504. However, in some embodiments, generally speaking various non-linear flux loops may be used to implement the oscillators 1504, such as those having single-well potential, double-well potential, or various other potentials, such as a potential somewhere between a single-well potential and a double-well potential.

FIG. 16 is an additional high-level diagram illustrating oscillators included in a substrate of the thermodynamic chip mapped to logical neurons, weights, and biases of a given neuro-thermodynamic computing system, according to some embodiments.

While weights and biases are not shown in FIG. 15 for ease of illustration, respective ones of the visible neurons 1554 of FIG. 15 may each have an associated bias, and edges connecting the neurons 1554 may have associated weights. For example, FIG. 17 illustrates an arrangement of five visible neurons along with associated weights and biases. Each of the weights and biases (such as those shown in FIG. 16) may be mapped to oscillators in the thermodynamic chip, as well as the visible (and non-visible) neurons being mapped to oscillators in the thermodynamic chip. For example, FIG. 16 shows a portion of a thermodynamic chip, wherein weights and biases associated with a given neuron 1654 are shown. For example, bias 1656 may be a bias value for visible neuron 1654 and weights 1658 and 1660 may be weights for edges formed between visible neuron 1654 and other visible neurons of the thermodynamic chip. As shown in FIG. 16, each of the chip elements (visible neuron 1654, bias 1656, weight 1658, and weight 1660) may be mapped to separate ones of oscillators 1604. This may allow the visible neurons (and/or hidden neurons), weights, and biases to have independent degrees of freedom within a given thermodynamic chip that can separately evolve.

In some embodiments, oscillators associated with weights and biases, such as bias 1656 and weights 1658 and 1660, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

FIG. 17 illustrates example couplings between visible neurons, weights, and biases (e.g., synapses) of a thermodynamic chip, according to some embodiments.

In some embodiments, visible neurons, such as visible neurons 1554, may be linked via connected edges 1706. Furthermore, as shown in FIG. 17, such visible neurons may additionally be linked to corresponding biases (e.g., synapses), such as biases 1702, and to weights (e.g., synapses), such as weights 1704. Recall that neurons, weights, and biases are logical representations of physical oscillators. Such that when describing neurons, weights, and biases in FIG. 17 it should be understood that these elements are implemented using oscillators and couplings as shown in FIG. 15. Also, as discussed in FIGS. 5A-5C, the synapse oscillators may have a larger mass than the neuron oscillators, such that the synapse oscillators evolve over a longer timescale than a timescale in which the neurons oscillators evolve.

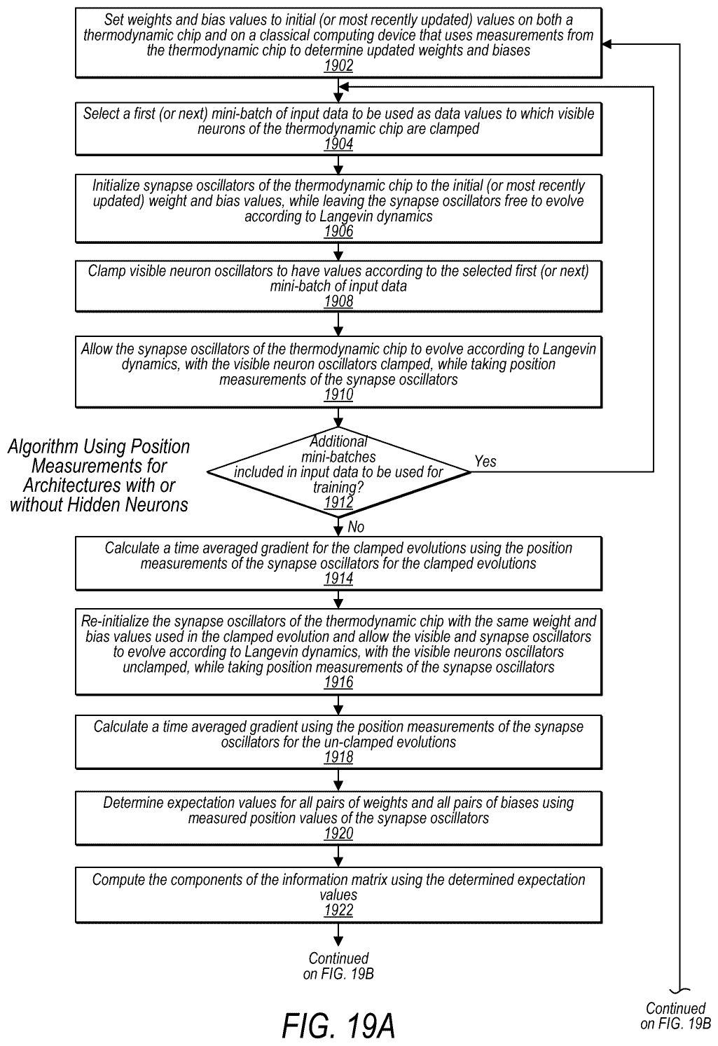

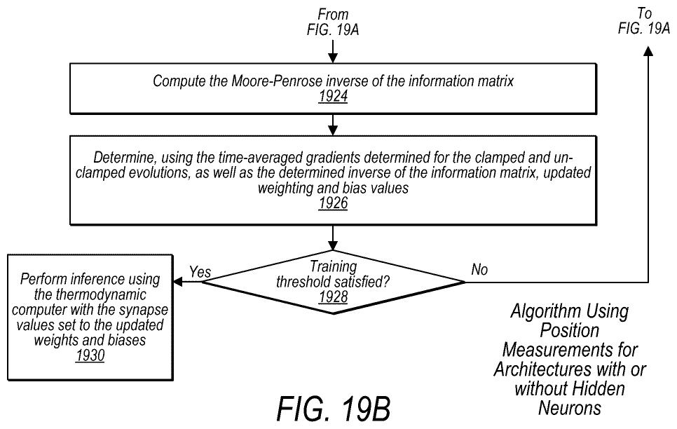

FIG. 18A illustrates example couplings between visible neurons of a thermodynamic chip, according to some embodiments.

In some embodiments, input neurons and output neurons, such as visible neurons 1802 and visible neurons 1804, may be directly linked via connected edges 1806. As shown in FIG. 18A, a given visible neuron 1802 of the five shown in the figure is connected, via edges 1806, to each of the respective three visible neurons 1804. A person having ordinary skill in the art should understand that FIG. 18A is meant to represent example embodiments of a graph architecture implemented using a thermodynamic chip that may be applied for image classification, for example, and that specific numbers of visible neurons 1802 and/or visible neurons 1804 shown in the figure are not meant to be restrictive. Additional configurations combining more/less visible neurons 1802 and/or visible neurons 1804 are also encompassed by the discussion herein. In addition, recall that neurons are logical representations of physical oscillators, such that, when describing neurons in FIGS. 18A and 18B, it should be understood that neurons and edges are implemented using oscillators and couplings as shown in FIG. 17.

FIG. 18B illustrates example couplings between visible neurons and non-visible neurons (e.g., hidden neurons) of a thermodynamic chip, according to some embodiments.

In some embodiments, FIG. 18B may resemble additional example embodiments of an architecture implemented using a thermodynamic chip. As shown in the figure, additional non-visible neurons 1808 may be used, which are respectively coupled, via edges 1806, to both visible neurons 1802 and to visible neurons 1804. Note that while the non-visible neurons are “not visible” from the perspective of inputs and outputs, the non-visible neurons may each correspond to a given oscillator, such as a given oscillator 1804 as shown in FIG. 15. In addition, it may be noted that, in some embodiments that make use of non-visible neurons, no direct connections, via edges 1806, may be implemented between visible neurons 1802 and visible neurons 1804, but rather connections are routed firstly via non-visible neurons 1808, as shown in FIG. 18B. Couplings between visible and non-visible neurons may be additionally referred to herein as “layers” of a given architecture that is implemented using a thermodynamic chip, according to some embodiments.

FIGS. 19A-19B illustrate an example algorithm for learning weights and bias values to be used in a Bayesian algorithm, based on position measurements taken of synapse oscillators of a thermodynamic chip, according to some embodiments.

At block 1902, weights and bias values are set to an initial (or most recently updated) set of values at both the thermodynamic chip, such as thermodynamic chip 102, and the classical computing device, such as classical computing device 104. For example, the set of weights and biases values used in block 1902 may be an initial starting point set of values from which energy-based model weights and biases will be learned, or the set of weights and biases used in block 1902 may be an updated set of weights and bias values from a previous iteration. For example, the energy-based model may have already been partially trained via one or more prior iterations of learning and the current iteration may further train the energy-based model.

At block 1904, a first (or next) mini-batch of input training data may be used as data values for the current iteration of learning. Also, the visible neurons of the thermodynamic chip will be clamped to the respective elements of the first (or next) mini-batch.

At block 1906, the synapse oscillators (which are also on the thermodynamic chip with the visible neurons oscillators that will be clamped to input data in block 1908) are initialized with the initial or current weight and bias values being used in the current iteration of learning. In contrast to the visible neuron oscillators, which will remain clamped during the clamped phase evolution, the synapse oscillators are free to evolve during the clamped phase evolution after being initialized with the current weight and bias values for the current iteration of learning.

At block 1908, the visible neuron oscillators are clamped to have the values of the elements of the mini-batch selected at block 1904.

At block 1910, the synapse oscillators evolve and measurements are taken for example, as shown in FIG. 5, wherein position measurements are performed in a small time interval centered around the beginning of the evolution of the synapse oscillators and the end of the evolution of the synapse oscillators. In some embodiments, the initial position measurements may be taken near time T₂ as shown in FIG. 6, or alternatively may be taken closer to time T₁.

At block 1912, it is determined if there are additional mini-batches for which clamped phase evolutions and position measurements are to be taken. If so, then the process may revert to block 1904 and be repeated for the next mini-batch.

If there are not additional mini-batches remaining to be used in the current learning iteration, then at block 1914, a time averaged gradient is calculated on the classical computing device, such as classical computing device 104, using the measurements taken at block 1910. The time averaged gradient for the clamped phase is given by:

[symbol]

ₜ^{(q)}[∇_{q}_{ₖ}U_{eff}^{(c)}(qₖ,x,z)]

where the superscript c refers to the clamped phase, and k represents the mini-batch segments of the input training data.

Next, at block 1916, the thermodynamic chip is re-initialized with the current weight and bias values (for the synapse oscillators) (e.g., the same weights and bias values as used to initialize prior the clamped phase, at block 1906). The visible neuron oscillators are then allowed to evolve (with both the visible neuron oscillators and the synapse oscillators un-clamped). While the oscillators are evolving, position measurements are taken, such as in FIG. 6 or FIG. 7.

At block 1918, the time-averaged gradient for the un-clamped phase is calculated on the classical computing device, such as classical computing device 104. The un-clamped phase time-averaged gradient is calculated using the measurements of the un-clamped evolution performed at block 1916. The time averaged gradient for the un-clamped phase is given by:

[symbol]

ₜ^{(q)}[∇_{q}_{ₖ}U_{eff}^{(uc)}(qₖ,x,z)]

where the superscript uc refers to the un-clamped phase, and k represents the current iteration of the learning.

At block 1920, expectation values for all pairs of weights and all pairs of biases are determined using the equation [symbol] ₜ^{(q)}[∂ᵢU(q,x,z)∂ⱼU(q,x,z)]. For example, measurements (as shown in FIG. 4), such as sets of two position measurements over time that approximate momentum and sets of three position measurements over time that approximate force, may be used as inputs to simple calculations performed on classical computing device 104 to determine the expectation values of the pairs of weights and biases.

At block 1922, all components of the information matrix are determined, for example at the classical computing device 104, based on measured position values. This is done using the following equation and measurement values as shown in FIG. 4.

$${I}_{i , j}^{B K M} = {𝔼}_{t} [ {\partial }_{i} U ( q , x , z ) {\partial }_{j} U ( q , x , z ) ] - {𝔼}_{t} [ {\partial }_{i} {U}_{e f f}^{( u c )} ( {q}_{k} , x , z ) ] {𝔼}_{t} [ {\partial }_{j} {U}_{e f f}^{( u c )} ( {q}_{k} , x , z ) ]$$

At block 1924 the Moore-Penrose inverse of the information matrix determined at block 1922 is calculated.

At block 1926, new weights and bias values are then determined using the time-averaged gradients determined at blocks 1914 and 1918. In some embodiments, the new weights and bias values are calculated on the classical computing device 104, using the following equation:

$${q}_{k + 1} = {q}_{k} + \frac{1}{{λ}_{t}} {I}^{+} ( - ∇ {q}_{k} {U}_{s} ( {q}_{k} ) - N ( \frac{1}{n} {\sum }_{i = 1}^{n} {𝔼}_{t}^{( q )} [ ∇ {q}_{k} {U}_{e f f}^{( c )} ( {q}_{k} , {x}_{t} , z ) ] - {𝔼}_{t}^{( q )} [ ∇ {q}_{k} {U}_{e f f}^{( u c )} ( {q}_{k} , x , z ) ] ) ) + {η}_{k}$$

where ηₖ is a noise term that can be computed using pre-conditioning methods.

At block 1928, it is determined whether a training threshold has been met, if so, the energy-based model is considered ready to perform inference, for example at block 1930. If not, the process reverts to 1902 and further training is performed using another set of training data.

FIGS. 20A-20B illustrate an example algorithm for learning weights and bias values to be used in a Bayesian algorithm, based on momentum measurements taken of synapse oscillators of a thermodynamic chip, according to some embodiments.

At block 2002, weights and bias values are set to an initial (or most recently updated) set of values at both the thermodynamic chip, such as thermodynamic chip 102, and the classical computing device, such as classical computing device 104. For example, the set of weights and biases values used in block 2002 may be an initial starting point set of values from which energy-based model weights and biases will be learned, or the set of weights and biases used in block 2002 may be an updated set of weights and bias values from a previous iteration.

At block 2004, a first (or next) mini-batch of input training data may be used as data values for the current iteration of learning. Also, the visible neurons of the thermodynamic chip will be clamped to the respective elements of the first (or next) mini-batch.

At block 2006, the synapse oscillators are initialized with the initial or current weight and bias values being used in the current iteration of learning. In contrast to the visible neuron oscillators, which will remain clamped during the clamped phase evolution, the synapse oscillators are free to evolve during the clamped phase evolution after being initialized with the current weight and bias values for the current iteration of learning.

At block 2008, the visible neuron oscillators are clamped to have the values of the elements of the mini-batch selected at block 2004.

At block 2010, the synapse oscillators evolve and measurements are taken for example, as shown in FIG. 9 (or alternatively as shown in FIG. 8), wherein momentum measurements are performed throughout the evolution of the synapse oscillators.

At block 2012, it is determined if there are additional mini-batches for which clamped phase evolutions and position measurements are to be taken. If so, then the process may revert to block 2004 and be repeated for the next mini-batch.

If there are not additional mini-batches remaining to be used in the current learning iteration, then at block 2014, a time averaged gradient is calculated on the classical computing device, such as classical computing device 104, using the measurements taken at block 2010. The time averaged gradient for the clamped phase is given by:

[symbol]

ₜ^{(q)}[∇_{q}_{ₖ}U_{eff}^{(c)}(qₖ,x,z)]

where the superscript c refers to the clamped phase, and k represents the mini-batch segments of the input training data.

Next, at block 2016, the thermodynamic chip is re-initialized with the current weight and bias values (for the synapse oscillators) (e.g., the same weights and bias values as used to initialize prior the clamped phase, at block 2006). The visible neuron oscillators are then allowed to evolve (with both the visible neuron oscillators and the synapse oscillators un-clamped). While the oscillators are evolving, momentum and force measurements (or approximations) are taken, such as in FIG. 8 or FIG. 9, and such as in FIG. 10 or FIG. 11.

At block 2018, the time-averaged gradient for the un-clamped phase is calculated on the classical computing device, such as classical computing device 104. The un-clamped phase time-averaged gradient is calculated using the measurements of the un-clamped evolution performed at block 2016. The time averaged gradient for the un-clamped phase is given by:

[symbol]

ₜ^{(q)}[∇_{q}_{ₖ}U_{eff}^{(uc)}(qₖ,x,z)]

where the superscript uc refers to the un-clamped phase, and k represents the current iteration of the learning.

At block 2020, expectation values for all pairs of weights and all pairs of biases are determined using the equation [symbol] ₜ^{(q)}[∂ᵢU(q,x,z)∂ⱼU(q,x,z)]. For example, measurements (as shown in FIG. 4), such as momentum and force measurements (or force approximations determined from measured sets of momentum), may be used as inputs to simple calculations performed on classical computing device 104 to determine the expectation values of the pairs of weights and biases.

At block 2022, all components of the information matrix are determined, for example at the classical computing device 104, based on measured momentum and force values. This is done using the following equation and measurement values as shown in FIG. 4.

$${I}_{i , j}^{B K M} = {𝔼}_{t} [ {\partial }_{i} U ( q , x , z ) {\partial }_{j} U ( q , x , z ) ] - {𝔼}_{t} [ {\partial }_{i} {U}_{e f f}^{( u c )} ( {q}_{k} , x , z ) ] {𝔼}_{t} [ {\partial }_{j} {U}_{e f f}^{( u c )} ( {q}_{k} , x , z ) ]$$

At block 2024 the Moore-Penrose inverse of the information matrix determined at block 2022 is calculated.

At block 2026, new weights and bias values are then determined using the time-averaged gradients determined at blocks 2014 and 2018. In some embodiments, the new weights and bias values are calculated on the classical computing device 104, using the following equation:

$${q}_{k + 1} = {q}_{k} + \frac{1}{{λ}_{t}} {I}^{+} ( - ∇ {q}_{k} {U}_{s} ( {q}_{k} ) - N ( \frac{1}{n} {\sum }_{i = 1}^{n} {𝔼}_{t}^{( q )} [ ∇ {q}_{k} {U}_{e f f}^{( c )} ( {q}_{k} , {x}_{t} , z ) ] - {𝔼}_{t}^{( q )} [ ∇ {q}_{k} {U}_{e f f}^{( u c )} ( {q}_{k} , x , z ) ] ) ) + {η}_{k}$$

where ηₖ is a noise term that can be computed using pre-conditioning methods.

At block 2028, it is determined whether a training threshold has been met, if so, the energy-based model is considered ready to perform inference, for example at block 2030. If not, the process reverts to 2002 and further training is performed using another set of training data.

FIG. 21 illustrates an example apparatus for measuring positions of oscillators of a thermodynamic chip using a flux read-out device, according to some embodiments.

In some embodiments, a resonator with a flux sensitive loop, such as resonator 2104 of flux readout apparatus 2102 may be used to measure flux and therefore position of an oscillator 1504 of thermodynamic chip 102. Note that flux is the analog of position for the oscillators used in thermodynamic chip 102. The flux of oscillator 1504 is measured by flux readout device 2102. For example, if the inductance of oscillator 1504 changes, it will also cause a change in the inductance of resonator 2104. This in turn causes a change in the frequency at which resonator 2104 resonates. In some embodiments, measurement device 2114 detects such changes in resonator frequency of resonator 2104 by sending a signal wave through the resonator 2104. The response wave that can be measured at measurement device 2114, will be altered due to the change in resonator frequency of resonator 2104, which can be measured and calibrated to measure the flux of oscillator 1504, and therefore the position of its corresponding neuron or synapse that is coded using that oscillator.

More specifically, in some embodiments, incoming flux 2106 from resonator 1504 is sensed by the inductor of resonator 2104, wherein flux tuning loop 2110 is used to tune the flux sensed by resonator 2104. Flux bias 2108 also biases the flux to flow through resonator 2104 towards transmission line 2112. In some embodiments, transmission line 2112 may carry the signal outside of a dilution refrigerator, such as dilution refrigerator 1202 shown in FIG. 12. Also, in some embodiments, transmission line 2112 may carry the signal to a classical computing device located within the dilution refrigerator, such as is shown for dilution refrigerator 1302 in FIG. 13. Measurement device 2114 may then be used to measure the signal representing the flux and may provide a flux measurement value and/or provide a position measurement value.

FIG. 22 illustrates an example apparatus for measuring momentums of oscillators of a thermodynamic chip using a charge read-out device, according to some embodiments.

As mentioned in the discussion of FIG. 21, flux of an oscillator of the thermodynamic chip corresponds to position. In a similar manner, a charge measurement of an oscillator corresponds to momentum. In some embodiments, a charge or current read out circuit, such as charge or current read out circuit 2202, may be used to measure charge of a given oscillator of the thermodynamic chip 102. In such an arrangement, the oscillator 1504 of thermodynamic chip 102 is represented by oscillator 2014, which is coupled to a SET island 2004 that appears as a small superconducting island from the perspective of the charge or current read out circuit 2202. For example, the charge or current read out circuit 2202 includes capacitances Ce, Cc, and Cg which are connected in the lower portion of the charge or current read out circuit 2202 as shown in FIG. 22. The Cg capacitance along with the voltage Vg is used to bias the charge on the SET island. The Ce capacitance along with the voltage V_{oscillator}, is used to bias the charge of the oscillator 1504, the Cc capacitance is the capacitance between the SET island 2204 and the oscillator 1504. The Cₛₑₜ island (e.g. SET island 2204) is used to measure the charge of the oscillator 1504 with capacitance C_{oscillator}, since the SET properties (2208) are sensitive to the charge on the SET island 2204, which is coupled to the oscillator charge. The amplifiers (cold and warm) and radio frequency signal source of signal processing 2210 are used to send the measured signal indicating the charge of the oscillator 1504 to a measurement device 2212, which may be a classical computing device, such as classical computing device 104.

### Illustrative Computer System

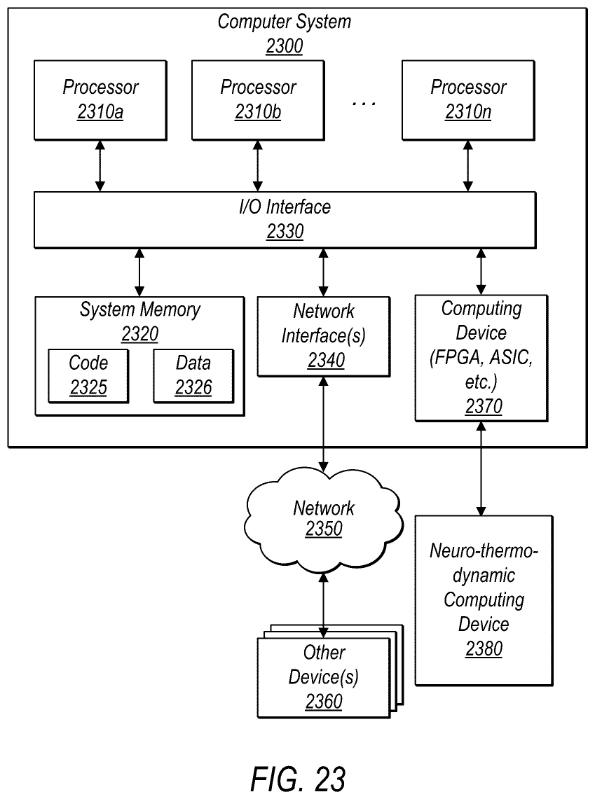

FIG. 23 is a block diagram illustrating an example computer system that may be used in at least some embodiments. In some embodiments, the computing system shown in FIG. 23 may be used, at least in part, to implement any of the techniques described above in FIGS. 1-22. Furthermore, computer system 2300 may be configured to interact and/or interface with self-learning neuro-thermodynamic computing device 2380, according to some embodiments.

In the illustrated embodiment, computer system 2300 includes one or more processors 2310 coupled to a system memory 2320 (which may comprise both non-volatile and volatile memory modules) via an input/output (I/O) interface 2330. Computer system 2300 further includes a network interface 2340 coupled to I/O interface 2330. Classical computing functions may be performed on a classical computer system, such as computing computer system 2300.

Additionally, computer system 2300 includes computing device 2370 coupled to thermodynamic chip 2380. In some embodiments, computing device 2370 may be a field programmable gate array (FPGA), application specific integrated circuit (ASIC) or other suitable processing unit. In some embodiments, computing device 2370 may be a similar computing device as described in FIGS. 1-22, such as classical computing devices 104. In some embodiments, neuro thermodynamic computing device 2380 may be a similar neuro thermodynamic computing device as described in FIGS. 1-22, such as neuro thermodynamic computing devices implemented using thermodynamic chip 102.

In various embodiments, computer system 2300 may be a uniprocessor system including one processor 2310, or a multiprocessor system including several processors 2310 (e.g., two, four, eight, or another suitable number). Processors 2310 may be any suitable processors capable of executing instructions. For example, in various embodiments, processors 2310 may be general-purpose or embedded processors implementing any of a variety of instruction set architectures (ISAs), such as the x86, PowerPC, SPARC, or MIPS ISAs, or any other suitable ISA. In multiprocessor systems, each of processors 2310 may commonly, but not necessarily, implement the same ISA. In some implementations, graphics processing units (GPUs) may be used instead of, or in addition to, conventional processors.

System memory 2320 may be configured to store instructions and data accessible by processor(s) 2310. In at least some embodiments, the system memory 2320 may comprise both volatile and non-volatile portions; in other embodiments, only volatile memory may be used. In various embodiments, the volatile portion of system memory 2320 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 2320 as code 2325 and data 2326.

In some embodiments, I/O interface 2330 may be configured to coordinate I/O traffic between processor 2310, system memory 2320, computing device 2370, and any peripheral devices in the computer system, including network interface 2340 or other peripheral interfaces such as various types of persistent and/or volatile storage devices. In some embodiments, I/O interface 2330 may perform any necessary protocol, timing or other data transformations to convert data signals from one component (e.g., system memory 2320) into a format suitable for use by another component (e.g., processor 2310). In some embodiments, I/O interface 2330 may include support for devices attached through various types of peripheral buses, such as a variant of the Peripheral Component Interconnect (PCI) bus standard or the Universal Serial Bus (USB) standard, for example. In some embodiments, the function of I/O interface 2330 may be split into two or more separate components, such as a north bridge and a south bridge, for example. Also, in some embodiments some or all of the functionality of I/O interface 2330, such as an interface to system memory 2320, may be incorporated directly into processor 2310.

Network interface 2340 may be configured to allow data to be exchanged between computing device 2300 and other devices 2360 attached to a network or networks 2350, such as other computer systems or devices. In various embodiments, network interface 2340 may support communication via any suitable wired or wireless general data networks, such as types of Ethernet network, for example. Additionally, network interface 2340 may support communication via telecommunications/telephony networks such as analog voice networks or digital fiber communications networks, via storage area networks such as Fibre Channel SANs, or via any other suitable type of network and/or protocol.

In some embodiments, system memory 2320 may represent one embodiment of a computer-accessible medium configured to store at least a subset of program instructions and data used for implementing the methods and apparatus discussed in the context of FIG. 1 through FIG. 22. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 2300 via I/O interface 2330. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 2300 as system memory 2320 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 2340. Portions or all of multiple computing devices such as that illustrated in FIG. 23 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and the Appendix below and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description and the Appendix below is to be regarded in an illustrative rather than a restrictive sense.

What is claimed is:

1. A system, comprising:
a thermodynamic chip comprising:
oscillators, wherein respective ones of the oscillators are configured to be coupled with one another in one or more configurations that correspond to one or more engineered Hamiltonians; and
one or more classical computing devices coupled to the thermodynamic chip, wherein the one or more classical computing devices are configured to:
receive, a first set of measurements comprising measurements of oscillators of the thermodynamic chip representing synapse values subsequent to one or more evolutions of the thermodynamic chip, wherein:
a first set of the oscillators representing visible neurons are clamped to input data;
receive, subsequent to an additional evolution of the thermodynamic chip, a second set of measurements of the oscillators of the thermodynamic chip representing synapse values, wherein during the additional evolution:
the first set of oscillators representing the visible neurons are not clamped;
determine a gradient value for use in computing the updated bias values and weighting values based on the first and second sets of measurements;
determine an information matrix for use in computing the updated bias values and weighting values based on the second set of measurements; and
and
determine updated bias values and weighting values based on the determined gradient value and the determined information matrix.

2. The system of claim 1, wherein the first set of oscillators of the thermodynamic chip further comprises oscillators that represent hidden neurons, and wherein at least some of the oscillators represent synapse values for the hidden neurons.

3. The system of claim 1, wherein the weights and biases values are trained using a Bayesian learning algorithm that uses a natural gradient descent optimization algorithm,
wherein the gradient value and the information matrix are used in the natural gradient descent optimization algorithm.

4. The system of claim 1, wherein to determine the gradient, the one or more classical computing devices use one or more momentums of the oscillators representing the synapse values.

5. The system of claim 4, wherein the one or more momentums are measured from the thermodynamic chip.

6. The system of claim 5, wherein the momentums measurements are determined based on respective charge values of the oscillators.

7. The system of claim 4, wherein the one or more momentums are calculated by the one or more classical computing devices based on positions of the oscillators representing the synapse values, wherein the positions are measured from the thermodynamic chip based on respective flux values of the oscillators.

8. The system of claim 1, wherein to determine the information matrix, the one or more classical computing devices use one or more oscillator forces of the oscillators representing the synapse values.

9. The system of claim 8, wherein the one or more oscillator forces are determined from sets of three or more positions of the oscillators, wherein the positions are measured from the thermodynamic chip.

10. The system of claim 8, wherein the one or more oscillator forces are determined from sets of two or more momentums of the oscillators, wherein the momentums are measured from the thermodynamic chip.

11. The system of claim 10, wherein the force measurements are determined based on charges of the oscillators representing the synapse values.

12. The system of claim 1, wherein the first and second sets of oscillators are dynamical degrees of freedom of the thermodynamic chip that evolve according to Langevin dynamics.

13. The system of claim 1, wherein masses assigned to the oscillators representing the synapse values are greater masses than masses assigned to the first set of oscillators representing the visible neurons, wherein, for respective ones of the oscillators, the oscillator's mass is represented by magnetic flux squared times capacitance (m=ϕ₀²C).

14. The system of claim 1, wherein the gradient value is determined based on a positive phase term, determined based on the first set of measurements, and a negative phase term, determined based on the second set of measurements.

15. A method of training a thermodynamic chip using natural gradient descent, the method comprising:
determining a gradient value for use in computing updated bias and weighting values for synapse oscillators of the thermodynamic chip, wherein the gradient value is determined based on a first set of measurements and a second set of measurements of oscillators of a thermodynamic chip representing synapse values, wherein:
oscillators of the thermodynamic chip corresponding to visible neurons are clamped to input data during evolution associated with the first set of measurements and
the oscillators of the thermodynamic chip corresponding to the visible neurons are un-clamped during evolution associated with the second set of measurements;
determining an information matrix for use in computing the updated bias and weighting values based on the second set of measurements; and
determining the updated bias and weighting values based on the determined gradient value and the determined information matrix.

16. The method of claim 15, wherein the first set of oscillators of the thermodynamic chip further comprises oscillators that represent hidden neurons, and wherein at least some of the oscillators represent synapse values for the hidden neurons.

17. The method of claim 15, further comprising:
measuring respective momentums of the synapse oscillators, wherein the measurements used to determine the gradient value comprise momentum measurements of the synapse oscillators.

18. The method of claim 15, further comprising:
measuring respective positions over time of the synapse oscillators, wherein the measurements used to determine the gradient value comprise position measurements of the synapse oscillators, and
wherein determining the gradient value comprises computing momentum values for the synapse oscillators based on the measured respective positions over time of the synapse oscillators.

19. The method of claim 15, further comprising:
performing momentum measurements of the synapse oscillators, wherein the measurements used to determine the information matrix comprise momentum measurements of the synapse oscillators and force values for the synapse oscillators determined based on momentum measurements.

20. The method of claim 15, further comprising:
measuring respective positions over time of the synapse oscillators, wherein the measurements used to determine the information matrix comprise position measurements of the synapse oscillators, and
wherein determining the information matrix comprises computing force values and momentum values for the synapse oscillators based on the measured respective positions over time of the synapse oscillators.

21. One or more non-transitory, computer-readable, storage media storing program instructions that, when executed on or across one or more processors, cause the one or more processors to:
receive, a first set of measurements comprising measurements of oscillators of thermodynamic chip representing synapse values subsequent to one or more evolutions of the thermodynamic chip, wherein:
a first set of oscillators of the thermodynamic chip representing visible neurons are clamped to input data;
receive, subsequent to an additional evolution of the thermodynamic chip, a second set of measurements, wherein during the additional evolution:
the first set of oscillators representing the visible neurons are not clamped;
determine a gradient value for use in computing updated bias values and weighting values based on the first and second sets of measurements;
determine an information matrix for use in computing the updated bias values and weighting values based on the second set of measurements; and
and
determine updated bias values and weighting values based on the determined gradient value and the determined information matrix.

22. The one or more non-transitory, computer-readable, storage media of claim 21, wherein the first and second set of measurements comprise, one or more of:
position measurements with respect to time of synapse oscillators of the thermodynamic chip;
momentum measurements of the synapse oscillators of the thermodynamic chip; or
force measurements of the synapse oscillators of the thermodynamic chip.
